(19) United States
(12) Patent Application Publication
(10) Pub. No.: US 2010/0029725 A1
(43) Pub. Date: Feb. 4, 2010

(54) RESISTANCE MANAGEMENT STRATEGIES

(75) Inventors: Daniel J. Cosgrove, Johnston, IA (US); Paula M. Davis, Grimes, IA (US); Robert C. Iwig, Johnston, IA (US)

Correspondence Address: MCKEE, VOORHEES & SEASE, P.L.C.;ATTN: PIONEER HI-BRED, 801 GRAND AVENUE, SUITE 3200, DES MOINES, IA, 50309-2721, US

(73) Assignee: PIONEER HI-BRED INTERNATIONAL, INC., JOHNSTON, IA (US)

(21) Appl. No.: 12/520,750

(22) PCT Filed: Dec. 26, 2007
(86) PCT No.: PCT/US07/88829

§ 371 Date: Jun. 22, 2009

Related U.S. Application Data
(60) Provisional application No. 60/871,671, filed on Dec. 22, 2006.

(51) Int. Cl. A01N 43/647; A01M 1/20; A01C 1/00; A01N 43/56; A01N 43/36; A01N 53/10; A01N 37/52; A01G 7/00; A01P 13/00; A01P 7/04; A01P 3/00; A01P 5/00; A01P 1/00

(52) U.S. Cl. 514/359; 43/132.1; 47/58.1 SE; 514/406; 514/408; 514/531; 514/632

(57) ABSTRACT

Insect refuge strategies are described for the management of insect resistance development. The present invention relates generally to the control of pests that cause damage to crop plants, and in particular to corn plants, by their feeding activities directed to root damage, and more particularly to the control of such plant pests by exposing target pests to seeds or mixtures of seeds having multiple different modes of action. The first one or more transgenes and the second one or more transgenes are each, respectively, insecticidal to the same target insect but have different modes of action, and bind either semi-competitively or non-competitively to different binding sites in the target pest. In addition, the treatment of such seed with a chemical or peptide-associated pesticide prior to planting the seed is also disclosed.

### REFERENCE TO RELATED APPLICATIONS

This application claims priority to U.S. Provisional Application Ser. No. 60/871,671, filed Dec. 22, 2006, the contents of which are incorporated by reference in their entirety.

### FIELD OF THE INVENTION

The present invention relates to methods for managing the development of resistant pests.

### BACKGROUND OF THE INVENTION

Insects, nematodes, and related arthropods annually destroy an estimated 15% of agricultural crops in the United States and even more than that in developing countries. Yearly, these pests cause over $100 billion dollars in crop damage in the U.S. alone. In addition, competition with weeds and parasitic and saprophytic plants account for even more potential yield losses.

Some of this damage occurs in the soil when plant pathogens, insects and other such soil borne pests attack the seed after planting. In the production of corn, for example, much of the damage is caused by rootworms, insect pests that feed upon or otherwise damage the plant roots, and by cutworms, European corn borers, and other pests that feed upon or damage the above ground parts of the plant. General descriptions of the type and mechanisms of attack of pests on agricultural crops are provided by, e.g., Metcalf (1962), in Destructive and Useful Insects, 4th ed. (McGraw-Hill Book Co., NY); and Agrios (1988), in Plant Pathology, 3d ed. (Academic Press, NY).

In an ongoing seasonal battle, farmers must apply billions of gallons of synthetic pesticides to combat these pests. However, synthetic pesticides pose many problems. They are expensive, costing U.S. farmers alone almost $8 billion dollars per year. They force the emergence of insecticide-resistant pests, and they can harm the environment.

Because of concern about the impact of pesticides on public health and the health of the environment, significant efforts have been made to find ways to reduce the amount of chemical pesticides that are used. Recently, much of this effort has focused on the development of transgenic crops that are engineered to express insect toxicants derived from microorganisms. For example, U.S. Pat. No. 5,877,012 to Estruch et al. discloses the cloning and expression of proteins from such organisms as Bacillus, Pseudomonas, Clavibacter and Rhizobium into plants to obtain transgenic plants with resistance to such pests as black cutworms, armyworms, several borers and other insect pests. Publication WO/EP97/07089 by Privalle et al. teaches the transformation of monocotyledons, such as corn, with a recombinant DNA sequence encoding peroxidase for the protection of the plant from feeding by corn borers, earworms and cutworms. Jansens et al. (1997) Crop Sci., 37(5): 1616-1624, reported the production of transgenic corn containing a gene encoding a crystalline protein from Bt that controlled both generations of European Corn Borer (ECB). U.S. Pat. Nos. 5,625,136 and 5,859,336 to Koziel et al. reported that the transformation of corn with a gene from Bt that encoded for a δ-endotoxin provided the transgenic corn with improved resistance to ECB. A comprehensive report of field trials of transgenic corn that expresses an insecticidal protein from Bacillus thuringiensis (Bt) has been provided by Armstrong et al, in Crop Science, 35(2):550-557 (1995).

An environmentally friendly approach to controlling pests is the use of pesticidal crystal proteins derived from the soil bacterium Bacillus thuringiensis (Bt), commonly referred to as “Cry proteins” or “Cry peptides.” The Cry proteins are globular protein molecules which accumulate as protoxins in crystalline form during late stage of the sporulation of Bt. After ingestion by the pest, the crystals are solubilized to release protoxins in the alkaline midgut environment of the larvae. Protoxins (˜130 kDa) are converted into toxic fragments (˜66 kDa N terminal region) by gut proteases. Many of these proteins are quite toxic to specific target insects, but harmless to plants and other non-targeted organisms. Some Cry proteins have been recombinantly expressed in crop plants to provide pest-resistant transgenic plants. Among those, Bt-transgenic cotton and corn have been widely cultivated.

A large number of Cry proteins have been isolated, characterized and classified based on amino acid sequence homology (Crickmore et al., 1998, Microbiol. Mol. Biol. Rev., 62: 807-813). This classification scheme provides a systematic mechanism for naming and categorizing newly discovered Cry proteins. The Cry1 classification is the best known and contains the highest number of cry genes which currently totals over 130.

One biotype of western corn rootworm (WCRW), which deposits its eggs in soybeans and possibly other crop habitats, is now capable of causing significant injury to first-year corn (i.e., corn that has not systematically followed corn). This biotype is commonly called first-year corn rootworm or rotation-resistant corn rootworm. First-year corn may also be susceptible to rootworm injury when eggs remain in the soil for more than a year. In this situation, the eggs deposited in the plot remain dormant throughout the following year and then hatch the next year, when corn may again be planted in a two-year rotation cycle. Such rootworm activity is called extended diapause and is commonly associated with northern corn rootworm (NCRW), especially in the northwestern region of the Corn Belt.

Further, most countries, including the United States, require extensive registration requirements when transgenic crops are used in order to minimize the development of resistant pests, and thereby extend the useful life of known biopesticides. One of the most common examples of a refuge is where in a given crop, 80% of the seed planted may contain a transgenic event which kills a target pest (such as WCRW), but 20% of the seed must not contain that transgenic event. The goal of such a refuge strategy is prevent the target pests from developing resistance to the particular biopesticide produced by the transgenic crop. Because those target insects that reach maturity in the 80% transgenic area will likely be resistant to the biopesticide used there, the refuge permits adult WCRW insects to develop that are not resistant to the biopesticide used in the transgenic seeds. As a result, the non-resistant insects breed with the resistant insects, and, because the resistance gene is typically recessive, eliminate much of the resistance in the next generation of insects. The problem with this refuge strategy is that in order to produce susceptible insects, some of the crop planted must be susceptible to the pest, thereby reducing yield.

As indicated above, one concern is that resistant ECB, WCRW, or other pests will emerge. One strategy for combating the development of resistance is to select a recombinant corn event which expresses high levels of the insecticidal protein such that one or a few bites of a transgenic corn plant would cause at least total cessation of feeding and subsequent death of the pest, even if the pest is heterozygotic for the resistance trait (i.e., the pest is the result of a resistant pest mating with a non-resistant pest).

Another strategy would be to combine a second ECB or WCRW specific insecticidal protein in the form of a recombinant event in the same plant or in an adjacent plant, for example, another Cry protein or alternatively another insecticidal protein such as a recombinant acyl lipid hydrolase or insecticidal variant thereof. See, e.g., WO 01/49834. Preferably, the second toxin or toxin complex would have a different mode of action than the first toxin, and preferably, if receptors were involved in the toxicity of the insect to the recombinant protein, the receptors for each of the two or more insecticidal proteins in the same plant or an adjacent plant would be different so that if a change of function of a receptor or a loss of function of a receptor developed as the cause of resistance to the particular insecticidal protein, then it should not and likely would not affect the insecticidal activity of the remaining toxin which would be shown to bind to a receptor different from the receptor causing the loss of function of one of the two insecticidal proteins cloned into a plant. Accordingly, the first one or more transgenes and the second one or more transgenes are preferably insecticidal to the same target insect and bind without competition to different binding sites in the gut membranes of the target insect.

Still another strategy would combine a chemical pesticide with a pesticidal protein expressed in a transgenic plant. This could conceivably take the form of a chemical seed treatment of a recombinant seed which would allow for the dispersal into a zone around the root of a pesticidally controlling amount of a chemical pesticide which would protect root tissues from target pest infestation so long as the chemical persisted or the root tissue remained within the zone of pesticide dispersed into the soil.

Another alternative to the conventional forms of pesticide application is the treatment of plant seeds with pesticides. The use of fungicides or nematicides to protect seeds, young roots, and shoots from attack after planting and sprouting, and the use of low levels of insecticides for the protection of, for example, corn seed from wireworm, has been used for some time. Seed treatment with pesticides has the advantage of providing for the protection of the seeds, while minimizing the amount of pesticide required and limiting the amount of contact with the pesticide and the number of different field applications necessary to attain control of the pests in the field.

Other examples of the control of pests by applying insecticides directly to plant seed are provided in, for example, U.S. Pat. No. 5,696, 144, which discloses that ECB caused less feeding damage to corn plants grown from seed treated with a 1 -arylpyrazole compound at a rate of 500 g per quintal of seed than control plants grown from untreated seed. In addition, U.S. Pat. No. 5,876,739 to Turnblad et al. (and its parent, U.S. Pat. No. 5,849,320) disclose a method for controlling soil-borne insects which involves treating seeds with a coating containing one or more polymeric binders and an insecticide. This reference provides a list of insecticides that it identifies as candidates for use in this coating and also names a number of potential target insects.

Although recent developments in genetic engineering of plants have improved the ability to protect plants from pests without using chemical pesticides, and while such techniques such as the treatment of seeds with pesticides have reduced the harmful effects of pesticides on the environment, numerous problems remain that limit the successful application of these methods under actual field conditions.

Insect resistance management (IRM) is the term used to describe practices aimed at reducing the potential for insect pests to become resistant to a pesticide. Maintenance of Bt IRM is of great importance because of the threat insect resistance poses to the future use of Bt plant-incorporated protectants and Bt technology as a whole. Specific IRM strategies, such as the high dose/structured refuge strategy, mitigate insect resistance to specific Bt proteins produced in corn, cotton, and potatoes. However, such strategies result in portions of crops being left susceptible to one or more pests in order to ensure that non-resistant insects develop and become available to mate with any resistant pests produced in protected crops. Accordingly, from a farmer/producer's perspective, it is highly desirable to have as small a refuge as possible and yet still manage insect resistance, in order that the greatest yield be obtained while still maintaining the efficacy of the pest control method used, whether Bt, chemical, some other method, or combinations thereof.

The most frequently-used current IRM strategy is a high dose and the planting of a refuge (a portion of the total acreage using non-Bt seed), as it is commonly-believed that this will delay the development of insect resistance to Bt crops by maintaining insect susceptibility. The high dose/refuge strategy assumes that resistance to Bt is recessive and is conferred by a single locus with two alleles resulting in three genotypes: susceptible homozygotes (SS), heterozygotes (RS), and resistant homozygotes (RR). It also assumes that there will be a low initial resistance allele frequency and that there will be extensive random mating between resistant and susceptible adults. Under ideal circumstances, only rare RR individuals will survive a high dose produced by the Bt crop. Both SS and RS individuals will be susceptible to the Bt toxin. A structured refuge is a non-Bt portion of a grower's field or set of fields that provides for the production of susceptible (SS) insects that may randomly mate with rare resistant (RR) insects surviving the Bt crop to produce susceptible RS heterozygotes that will be killed by the Bt crop. This will remove resistant (R) alleles from the insect populations and delay the evolution of resistance. MON810 and BT11 are currently-available products believed to be “high dose.”

The high dose/refuge strategy is the currently-preferred strategy for IRM. Non-high dose strategies are currently used in an IRM strategy by increasing refuge size. The refuge is increased because lack of a high dose could allow partially resistant (i.e., heterozygous insects with one resistance allele) to survive, thus increasing the frequency of resistance genes in an insect population. For this reason, numerous IRM researchers and expert groups have concurred that non-high dose Bt expression presents a substantial resistance risk relative to high dose expression (Roush 1994, Gould 1998, Onstad & Gould 1998, SAP 1998, ILSI 1998, UCS 1998, SAP 2001). However, such non-high dose strategies are typically unacceptable for the farmer, as the greater refuge size results in further loss of yield.

Currently, the size, placement, and management of the refuge is considered critical to the success of the high dose/structured refuge strategy to mitigate insect resistance to the Bt proteins produced in corn, cotton, and potatoes. Structured refuges are generally required to include all suitable non-Bt host plants for a targeted pest that are planted and managed by people. These refuges could be planted to offer refuges at the same time when the Bt crops are available to the pests or at times when the Bt crops are not available. The problems with these types of refuges include ensuring compliance with the requirements by individual farmers. Because of the decrease in yield in refuge planting areas, some farmers choose to eschew the refuge requirements, and others do not follow the size and/or placement requirements. These non-compliance issues result in either no refuge or less effective refuge, and a corresponding increase in the development of resistance pests.

### European Corn Borer (ECB)

ECB is a major pest of corn throughout most of the United States. The pest has 1-4 generations per year, with univoltine (i.e., one generation per year) populations in the far North (i.e., all of North Dakota, northern South Dakota, northern Minnesota, and northern Wisconsin), bivoltine (i.e., two generations per year) populations throughout most of the Corn Belt, and multivoltine (3-4 generations) populations in the South (Mason et al. 1996). A summary of key aspects of ECB biology that relate to IRM is presented below:

### Larval Movement

ECB larvae are capable of significant, plant-to-plant movement within corn fields. Research conducted in non-transgenic corn showed that the vast majority of larvae do not move more than two plants within a row (Ross & Ostlie 1990). However, in transgenic corn, unpublished data (used in modeling work) from F. Gould (cited in Onstad & Gould 1998) indicates that approximately 98% of susceptible ECB neonates move away from plants containing Bt. Recent multi-year studies by Hellmich (1996, 1997, 1998) have attempted to quantify the extent of plant-to-plant larval movement. It was observed that 4th instar larvae were capable of movement up to six corn plants within a row and six corn plants across rows from a release point. Movement within a row was much more likely than movement across rows (not surprising, due to the fact that plants within are row are more likely to be “touching” as opposed to those across rows). In fact, the vast majority of across row movement was limited to one plant. This type of information has obvious implications for optimal refuge design. Larvae moving across Bt and non-Bt corn rows may be exposed to sublethal doses of protein, increasing the likelihood of resistance (Mallet & Porter 1992). Given the extent of ECB larval movement between plants, prevailing belief is that seed mixes are an inferior refuge option (Mallet & Porter 1992, SAP 1998, Onstad & Gould 1998).

### Adult Movement

Information on movement of adult ECB (post-pupal eclosion) is necessary to determine appropriate proximity guidelines for refuges. Refuges must be established within the flight range of newly emerged adults to help ensure the potential for random mating. An extensive, multi-year project to investigate ECB adult dispersal was undertaken by the University of Nebraska (Hunt et al. 1997, 1998a). Results from these mark and recapture studies (with newly emerged, pre-mated adults) showed that the majority of ECB adults did not disperse far from their emergence sites. The percentage recaptured was very low (<1%) and the majority of those that were recaptured were caught within 1500 feet of the release site. Few moths were captured outside of 2000 feet. These results have specifically led to recommendations and guidelines for refuge proximity and deployment.

### Mating Behavior

In addition to patterns of adult movement, ECB mating behavior is an important consideration to insure random mating between susceptible and potentially resistant moths. In particular, it is important to determine where newly emerged females mate (i.e., near the site of emergence or after some dispersal). It is well established that many ECB take advantage of aggregation sites (usually clusters of weeds or grasses) near corn fields for mating. Females typically mate the second night after pupal eclosion (Mason et al. 1996). One recent study suggested that it may be possible to manipulate aggregation sites to increase the likelihood of random mating between susceptible and potentially resistant ECB (Hellmich et al. 1998). Another recent study (mark/recapture studies with newly enclosed ECB) conducted by the University of Nebraska showed that relatively few unmated females moved out of the corn field from which they emerged as adults (Hunt et al. 1998b). This was especially true in irrigated (i.e., attractive) corn fields. In addition, a relatively high proportion of females captured close to the release point (within 10 feet) were mated. This work suggests that females mate very close to the point of emergence and that refuges may need to be placed very close to Bt fields (or as in-field refuges) to maximize the probability of random mating.

In terms of male mating behavior, a study by Showers et al. (2001) looked at male dispersal to locate mates. The study was carried out using mark-recapture techniques with pheromone-baited traps placed at 200, 800, 3200, and 6400 m from a release point. Results showed that males in search of mates were trapped more frequently at traps placed at 200 m from the release site. However, significant numbers were also trapped at 800 m or greater from the release site (Showers et al. 2001). Similar to Hunt et al., this work suggests that refuges may need to be placed relatively close to Bt fields to maximize random mating.

### Ovipositional Behavior

ECB ovipositional (egg-laying) behavior is also important for refuge design. For instance, if oviposition within a corn field is not random, certain types of refuge (i.e., in-field strips) may not be effective. After mating, which occurs primarily in aggregation sites, females move to find suitable corn hosts for oviposition. Most females will oviposit in corn fields near the aggregation sites, provided there are acceptable corn hosts. Oviposition begins after mating and occurs primarily at night. Eggs are laid in clusters of up to sixty eggs (one or more clusters are deposited per night) (Mason et al. 1996).

It is known that females generally prefer taller and more vigorous corn fields for oviposition (Beck 1987). This has implications for refuge design. To avoid potential host discrimination among ovipositing females, the non-Bt corn hybrid selected for refuge should similar to the Bt hybrid in terms of growth, maturity, yield, and management practices (i.e., planting date, weed management, and irrigation). It should be noted that research has shown no significant difference in ovipositional preferences between Bt and non-Bt corn (derived from the same inbred line) when phenological and management characteristics are similar (Orr & Landis 1997, Hellmich et al. 1999). Within a corn field suitable for egg laying, oviposition is thought to be random and not restricted to border rows near aggregation sites (Shelton et al. 1986, Calvin 1998).

### Host Range

ECB is a polyphagous pest known to infest over 200 species of plants. Among the ECB plant hosts are a number of species of common weeds, which has led some to speculate that it may be possible for weeds to serve as an ECB refuge for Bt corn, a concept commonly referred to as “unstructured refuge.” In response to this, a number of recent research projects have investigated the feasibility of weeds as refuge. Studies conducted by Hellmich (1996, 1997, 1998) have shown that weeds are capable of producing ECB, although the numbers were variable and too inconsistent to be a reliable source of ECB refuge. This conclusion was also reached by the 1998 SAP Subpanel on IRM. In addition to weeds, a number of grain crops (e.g., wheat, sorghum, oats) have been investigated for potential as a Bt corn ECB refuge (Hellmich 1996, 1997, 1998, Mason et al. 1998). In these studies, small grain crops generally produced less ECB than corn (popcorn or field corn) and were therefore considered unlikely to produce enough susceptible adult insects to be an acceptable refuge. Therefore, based on the current state of the art, an improved IRM for ECB is needed.

### Corn Earworm (CEW)

As with ECB, the 1998 SAP identified a number of research areas that need additional work with CEW. In addition to increased knowledge regarding larval/adult movement, mating behavior, and ovipositional behavior, a better understanding of movement between corn/cotton and long distance migration is also needed (SAP 1998). Additional research regarding CEW biology has occurred since 1998. These data have been submitted as part of the annual research reports required as a condition of registration of such Bt crops before commercial use is permitted. The Agency has reviewed these data and has concluded that additional information would be useful for effective long-term improvements of IRM strategies to mitigate CEW resistance.

### Host Range and Corn to Cotton Movement

CEW is a polyphagous insect (3-4 generations per year), feeding on a number of grain and vegetable crops in addition to weeds and other wild hosts. Typically, it is thought that CEW feeds on wild hosts and/or corn for two generations (first generation on whorl stage corn, second generation on ear stage corn). After corn senescence, CEW moves to other hosts, notably cotton, for 2-3 additional generations. By utilizing multiple hosts within the same growing season, CEW presents a challenge to Bt resistance management in that there is the potential for double exposure to Bt protein in both Bt corn and Bt cotton (potentially up to five generations of exposure in some regions).

### Overwintering Behavior

CEW are known to overwinter in the pupal stage. Although it is known that CEW migrate northward during the growing season to corn-growing regions (i.e., the U.S. Corn Belt and Canada), CEW typically are not capable of overwintering in these regions. Rather, CEW are known to overwinter in the South, often in cotton fields. Temperature, moisture, and cultivation practices are all thought to play some role in the overwintering survival of CEW (Caprio & Benedict 1996).

Overwintering is an important consideration for IRM-resistant insects must survive the winter to pass their resistance genes on to future generations. In the Corn Belt, for example, CEW incapable of overwintering should not pose a resistance threat. Given that different refuge strategies may be developed based upon where CEW is a resistance threat, accurate sampling data would help to precisely predict suitable CEW overwintering areas.

### Adult Movement and Migration

CEW is known to be a highly mobile pest, capable of significant long distance movement. Mark/recapture studies have shown that CEW moths are capable of dispersing distances ranging from 0.5 km (0.3 mi.) to 160 km (99 mi.); some migration up to 750 km (466 mi.) was also noted (Caprio & Benedict 1996). The general pattern of migration is a northward movement, following prevailing wind patterns, with moths originating in southern overwintering sites moving to corn-growing regions in the northern U.S. and Canada.

It has been assumed that CEW migration proceeds progressively northward through the course of the growing season. However, observations made by Dr. Fred Gould (N.C. State University) indicate that CEW may also move southward from corn-growing regions back to cotton regions in the South (described in remarks made at the 1999 EPA/USDA Workshop on Bt Crop Resistance Management in Cotton, Memphis, Tenn. Aug. 26, 1999). If this is true, the result may be additional CEW exposure to Bt crops. In addition, the assumptions regarding CEW overwintering may need to be revisited—moths that were thought to be incapable of winter survival (and thus not a resistance threat) may indeed be moving south to suitable overwintering sites.

Most CEW flight movement is local, rather than migratory. Heliothine moths move primarily at night, with post-eclosion moths typically flying short distances of less than 200 m (Caprio & Benedict 1996). However, as was indicated by the 1998 SAP, additional research would be useful, particularly as it pertains to CEW and optimal refuge design. On the other hand, given the long distance movements typical of CEW and the lack of high dose in Bt corn hybrids, the 2000 SAP noted that refuge placement for this pest is of less importance than with other pests (e.g., ECB) (SAP 2001).

### Mating/Ovipositional Behavior

Dr. Michael Caprio (entomologist, Mississippi State University) has indicated that there is significant localized mating among females (i.e., within 600 m (1969 ft.) of pupal eclosion), typically with males that emerged nearby or moved in prior to female eclosion (Caprio 1999). CEW females typically deposit eggs singly on hosts. A recent study (conducted in cotton fields) found that 20% of the eggs found from released CEW females were within 50-100 m (164-328 ft.) of the release point, indicating some localized oviposition. However, males were shown to be able to move over 350 m (1148 ft.) to mate with females (Caprio 2000). These data indicate that, in terms of CEW, refuges may not have to be embedded or immediately adjacent to a Bt field to be effective (although the data do not exclude these options). Additional research with mating and ovipositional behavior would provide useful information for CEW IRM.

### Larval Movement

CEW larvae, particularly later instars, are capable of plant-to-plant movement. At the recommendation of the SAP (1998), the EPA has eliminated seed mixes as a viable Bt cotton refuge option for CEW. Accordingly, an improved IRM strategy for CEW is also needed.

### Southwestern Corn Borer

Some SWCB pest biology data have been provided to the EPA as part of the annual research reports required as a condition of registration. However, there is still relatively limited information available. The 1998 SAP noted the relative lack of information for SWCB, concluding that critical research is needed for SWCB, including: short-term movement, long-distance migration, mating behavior relative to movement (i.e. does mating occur before or after migration). Because of this, in the current state of the art, it is unknown whether IRM strategies designed for ECB (another corn boring pest) will also function optimally for SWCB.

SWCB is an economic pest of corn in some areas (i.e., SW Kansas, SE Colorado, northern Texas, western Oklahoma) and can require regular management. Like ECB, SWCB has 2-4 generations and similar feeding behavior. First generation larvae feed on whorl tissue before tunneling into stalks before pupation, while later generations feed on ear tissue before tunneling into stalks. Females typically mate on the night of emergence and can lay 250-350 eggs (Davis 2000).

Research to investigate the movement patterns of SWCB has been initiated (Buschman et al. 1999). In this mark/recapture study, the following observations were made regarding SWCB from the 1999 data: 1) more males than females were captured at greater distances from the release point (similar to ECB); 2) most recaptures of SWCB were within 100 feet of the release site, although some were also noted at 1200 feet; and 3) the moth movement patterns for ECB and SWCB appear to be similar in most regards. Given these results, it is likely that this part of the IRM strategy (refuge proximity guidelines established for ECB) will also be applicable to SWCB. However, the 1999 results were hampered by low SWCB numbers available for testing and the authors have indicated that this work will continue during the 2000 season.

Research for other secondary pests (e.g., BCW, FAW, SCSB, others) is also lacking and could be useful for specific regions in which these pests may pose an additional concern. However, the 1998 SAP indicated that CEW and SWCB should have the highest priority for biology research among the secondary corn pests.

Based on these characteristics and behavior in agricultural pests, the most commonly used refuge strategy is known as a “block” refuge or “strip” refuge. The NC-205 group has recommended three options for refuge placement relative to Bt corn: blocks planted adjacent to fields, blocks planted within fields, or strips planted within fields (Ostlie et al. 1997). In general, refuges may be deployed as external blocks on the edges or headlands of fields or as strips within the Bt corn field. Research has shown that ECB larvae are capable of moving up to six corn plants within or between rows with the majority of movement occurring within a single row. Later instar (4th and 5th) ECB are more likely to move within rows than between rows (Hellmich 1998). This is a cause for concern because heterozygous (partially resistant) ECB larvae may begin feeding on Bt plants, then move to non-Bt plants (if planted nearby) to complete development, thus defeating the high dose strategy and increasing the risk of resistance. For this reason, seed mixes (refuge created by mixing seed in the hopper) are not typically recommended refuges (Mallet & Porter 1992, Buschman et al. 1997).

Buschman et al. (1997) suggested that the within field refuge is the ideal strategy for an IRM program. Since the ECB larvae tend to move within rows, the authors suggest intact corn rows as an acceptable refuge. Narrow (filling one or two planter boxes with non-Bt corn seed) or wide strips (filling the entire planter with non-Bt seed) may be used as in-field refuges. Data indicate that in-field strips may provide the best opportunity for ECB produced in Bt corn to mate with ECB from non-Bt corn. Since preliminary data suggests that the refuge should be within 100 rows of the Bt corn, Buschman et al. (1997) recommended alternating strips of 96 rows of non-Bt corn and 192 rows of Bt corn. This would result in a 33% refuge that is within 100 rows of the Bt corn.

Currently, in-field strips (planted as complete rows) should extend the full length of the field and include a minimum of six rows planted with non-Bt corn alternating with a Bt corn hybrid. NC-205 has recommended planting six to 12 rows of non-Bt corn when implementing the in-field strip refuge strategy (NC 205 Supplement 1998). The 2000 SAP also agreed that, due to larval movement, wider refuge strips are superior to narrower strips, although planter sizes may restrict strip sizes for some smaller growers (SAP 2001). In-field strips may offer the greatest potential to ensure random mating between susceptible and resistant adults because they can maximize adult genetic mixing. Modeling indicates that strips of at least six rows wide are as effective for ECB IRM as adjacent blocks when a 20% refuge is used (Onstad & Guse 1999). However, strips that are only two rows wide might be as effective as blocks, but may be more risky than either blocks or wider strips given our incomplete understanding of differences in survival between susceptible borers and heterozygotes (Onstad & Gould 1998).

Given the current concerns with larval movement and need for random mating, either external blocks or in-field strips (across the entire field, at least 6 rows wide) are the refuge designs which may provide the most reduction in risk of resistance development. Research indicates that random mating is most likely to occur with in-field strips. However, as noted previously, this IRM strategy presents problems both from a crop damage and farmer compliance perspective.

Further, based on existing scientific belief, refuges must currently be located so that the potential for random mating between susceptible moths (from the refuge) and possible resistant survivors (from the Bt field) is maximized. Therefore, pest flight behavior is a critical variable to consider when discussing refuge proximity. Refuges planted as external blocks should be adjacent or in close proximity to the Bt corn field (Onstad & Gould 1998, Ostlie et al. 1997b). NC-205 initially recommended that refuges should be planted within ½ sections (320 acres) (NC-205 Supplement 1998). Subsequently, the recommendation was revised to specify that non-Bt corn refuges should be placed within ½ mile of the Bt field (¼ mile would be even better) (Ortman 1999).

Hunt et al. (1997) has completed a study which suggests that the majority of ECB do not disperse far from their pupal emergence sites. According to this mark-recapture study, the majority of ECB may not disperse more than 1500 to 2000 feet. A majority (70-98%) of recaptured ECB were trapped within 1500 feet of the release point. However, in an addendum to the 1997 study, the authors caution that the 1500 foot distance does not necessarily represent the maximum dispersal distance for ECB (Hunt et al. 1998a).

Another mark-recapture ECB project was devoted to within-field movement of emerging ECB (in particular unmated females) (Hunt et al. 1998b). Relatively few unmated females were recaptured (10 over the entire experiment), although the majority of those were found within 85 ft of the release point. This suggests that unmated females may not disperse far from the point of pupal eclosion (this was especially true in the irrigated field). In addition, a relatively high proportion of mated females (31%) in irrigated fields were trapped within 10 feet of the release point, suggesting that mating occurred very close to the point of emergence. Both of these observations indicate that many emerging ECB females may not disperse outside of their field of origin. With respect to resistance management and refuge proximity, these results suggest that refuges should be placed in close proximity to Bt corn fields (or as in-field refuge) to increase the chance of random mating (especially for irrigated fields).

In terms of male ECB dispersal, another mark-recapture study by Showers et al. (2001) showed that males dispersing in search of mates may move significant distances (>800 m). However, a greater percentage of males were trapped at closer distances (200 m) to the release point. Based on this research, the authors suggest that, in terms of male movement, the current refuge proximity guidelines of ½ mile should be adequate to ensure mating between susceptible moths and any resistant survivors from the Bt field.

While it is clear that ECB dispersal decreases further from pupal emergence points, the quantitative dispersal behavior of ECB has not been fully determined. However, in terms of optimal refuge placement, under currently-accepted standards, it is considered critical that refuge proximity be selected to maximize the potential for random mating. Based on Hunt et al. data, the closer the refuge is to the Bt corn, the lower the risk of resistance. Since the greatest number of ECB were captured within 1500 feet of the field and most females may mate within ten feet of the field, placing refuges as close to the Bt fields as possible should increase the chance of random mating and decrease the risk of resistance. Currently, the proximity requirement for Bt corn is ½ mile (¼ mile in areas where insecticides have been historically used to treat ECB and SWCB) (EPA letter to Bt corn registrants, Jan. 31, 2000). The 2000 SAP agreed with this guideline, stating that refuges should be located no further than a half mile (within ¼ mile if possible) from the Bt corn field (SAP 2001).

Of course, each of these refuge options (block, strip, and the like) presents additional challenges in their execution. As noted previously, these methods leave portions of a farmer's field susceptible to insect infestation in order to ensure that susceptible insects develop and are available to mate with any resistant pests in the field. This results in a substantial loss of yield, as currently such refuges must encompass at least 20% of the field. Because of the decreased yield associated with the refuge portion of transgenic pest resistant crops, there are also issues with farmer compliance with the refuge requirements as noted previously.

### Temporal and Spatial Refuge

The use of temporal and spatial mosaics has received some attention as alternate strategies to structured refuge to delay resistance. A temporal refuge, in theory, would manipulate the life cycle of ECB by having the Bt portion of the crop planted at a time in which it would be most attractive to ECB. For example, Bt corn fields would be planted several weeks before conventional corn. Because ECB are thought to preferentially oviposit on taller corn plants, the hope is that the Bt corn will be infested instead of the shorter, less attractive conventional corn. However, there are indications from experts in the field that temporal refuges are an inferior alternative to structured refuges (SAP 1998). Research has shown that planting date cannot be used to accurately predict and manipulate ECB oviposition rates (Calvin et al. 1997, Rice et al. 1997, Ostlie et al. 1997b, Calvin 1998). Local climatic effects on corn phenology make planting date a difficult variable to manipulate to manage ECB. Additional studies will have to be conducted under a broad range of conditions to fully answer this question. In addition, a temporal mosaic may lead to assertive mating in which resistant moths from the Bt crop mate with each other because their developmental time differs from susceptible moths emerging from the refuge (Gould 1994).

Spatial mosaics involve the planting of two separate Bt corn events, with different modes of action. The idea is that insect populations will be exposed to multiple proteins, reducing the likelihood of resistance to any one protein. However, currently-registered products only express one protein and the primary pests of corn (ECB, CEW, SWCB) generally remain on the same plant throughout the larval feeding stages, individual insects will be exposed to only one of the proteins. In the absence of structured refuges producing susceptible insects, resistance may still have the potential to develop in such a system as it would in a single protein monoculture. As a result, the currently-accepted view teaches away from the types of refuge strategies disclosed herein.

It is known that during the growing season CEW move northward from southern overwintering sites to corn-growing regions in the Corn Belt. However, observations of CEW north to south migration (from corn-growing regions to cotton-growing regions) have been noted. Although more research is needed for confirmation, this phenomenon could result in additional exposure to Bt crops and increased selection pressure for CEW resistance. This effect is compounded by the fact that neither Bt cotton or any registered Bt corn event contains a high dose for CEW. As such, it may be necessary to consider additional mitigation measures for CEW.

In considering this issue, the 2000 SAP indicated that CEW refuge is best considered on a regional scale (instead of structured refuge on an individual farm basis), due to the long distance movements typical of this pest (i.e., refuge proximity is not as important for CEW). According to the SAP, a 20% refuge (per farm) would be adequate for CEW, provided the amount of Bt corn in the region does not exceed 50% of the total corn crop. If the regional Bt corn crop exceeds 50%, however, additional structured refuge may be necessary (SAP 2001). However, the SAP did not define what a “region” should be (i.e., county, state, or other division).

Based on the last available acreage data for Bt corn, it should be noted that a number of counties in the Corn Belt exceed the 50% threshold recognized by the 2000 SAP. Because of this, there may be additional risk for CEW resistance. This risk could be mitigated with additional structured refuge in regions with greater than 50% Bt corn. However, additional research will likely be needed to fully determine the risk of CEW north-south movement and appropriate mitigation measures.

### Currently-Accepted Refuge Options

### High Dose Events, MON 810, BT11, and TC1507 (Field Corn)

### Non-Cotton Regions that do not Spray Insecticides on a Regular Basis

This region encompasses most of the Corn Belt east of the High Plains. The original USDA NC-205 refuge recommendations included a 20-30% untreated structured refuge or a 40% refuge that could be treated with non-Bt insecticides (Ostlie et al. 1997a). In the case of ECB, the primary pest of corn for most of the U.S., it is known that on average less than 10% of growers use insecticide treatment to control this pest (National Center for Food and Agriculture Policy 1999). Because many growers do not regularly treat for ECB, NC-205 modified their position in a May 24, 1999 letter to Dr. Janet Andersen (Director, BPPD). In this letter, NC-205 amended their recommendation to a 20% non-Bt corn refuge that may be treated with insecticides and should be deployed within ½ mile (¼ mile is better) of the Bt corn. Specific recommendations in the letter were: 1) insecticide treatment of refuges should be based on scouting and accepted economic thresholds, 2) treatment should be with a product that does not contain Bt or Cry toxin, 3) records should be kept of treated refuges and shared with the EPA, 4) the potential impact of sprayed refuges should be monitored closely and evaluated annually, and 5) monitoring for resistance should be most intense in higher risk areas, for example where refuges are treated with insecticides (Ortman 1999).

Since most growers do not typically treat field corn with insecticides to control ECB, a refuge of 20% non-Bt corn that may be sprayed with non-Bt insecticides if ECB densities exceed economic thresholds should be viable for the Corn Belt. Refuges can be treated as needed to control lepidopteran stalk-boring insects with non-Bt insecticides or other appropriate IPM practices. Insecticide use should be based on scouting using economic thresholds as part of an IPM program.

Some laboratory studies demonstrate that the Cry2Ab protein alone and the Cry2Ab+Cry1 Ac proteins as expressed in Bollgard II produce a functional “high dose” in Bollgard II cotton for control of CBW, TBW, and PBW. These studies will be discussed below. The EPA has previously concluded that a moderate, non-high dose of Cry1Ac is produced in current Bollgard lines to control CBW and a functional high dose of Cry1Ac is produced to control TBW and PBW (USEPA 1998, 2001).

The following table will assist the reader with the acronyms for the insect pests. Note that the table lists the most common pests that are the target of transgenic pest resistance strategies, but the invention is not limited to only these pests.

TABLE 1

| Acronym | Common Name | Scientific Name | Crop |
|---|---|---|---|
| BCW | black cutworm | Agrotis ipsilon (Hufnagel) | corn |
| CBW | cotton bollworm | Helicoverpa zea (Boddie) | cotton |
| CEW | corn earworm | Helicoverpa zea (Boddie) | corn |
| CPB | Colorado potato beetle | Leptinotarsa decemlineata (Say) | potato |
| CSB | common stalk borer | Papaipema nebris (Guenee) | corn |
| ECB | European corn borer | Ostrinia nubilalis (Huebner) | corn |
| FAW | fall armyworm | Spodoptera frugiperda (J E Smith) | corn |
| PBW | pink bollworm | Pectinophora gossypiella (Saunders) | cotton |
| SCSB | southern corn stalk borer | Diatraea crambidoides (Grote) | corn |
| SWCB | southwestern corn borer | Diatraea grandiosella (Dyar) | corn |
| TBW | tobacco budworm | Heliothis virescens (Fabricius) | cotton |

Accordingly, there remains a need for methods for managing pest resistance in a plot of pest resistant crop plants. It would be useful to provide an improved method for the protection of plants, especially corn plants, from feeding damage by pests. It would be particularly useful if such a method would reduce the required application rate of conventional chemical pesticides, and also if it would limit the number of separate field operations that were required for crop planting and cultivation.

### SUMMARY OF THE INVENTION

The invention therefore relates to a method of reducing the development of resistant pests in a field by mixing seed of a first transgenic pest resistant crop with seed of a second transgenic pest resistant crop to provide a seed mixture where the first pest resistant crop and said second pest resistant crop are pesticidal to the same target pest but through a different mode of pesticidal action, and planting the seed mixture. The seeds may further incorporate a herbicide resistance gene.

The invention further relates to a method of reducing the development of resistant pests in a field of transgenic pest resistant crops in a plot by mixing a first type of seed and a second type of seed to produce a seed mixture, where the first type of seed is seed of a transgenic pest resistant crop plant comprising a first transgene and a second transgene and has pesticidal activity against a first target pest and a second target pest, and wherein the second type of seed does not have pesticidal activity against the first target pest or the second target pest, wherein said seed mixture comprises about 90% to about 99% of the first type of seed and from about 10% to about 1% of the second type of seed; and planting said seed mixture. The seeds may further incorporate a herbicide resistance gene.

The invention also relates to a method of managing pest resistance in a plot of pest resistant crops by providing seed of a first transgenic pest resistant crop, the first transgenic pest resistant crop expressing a first transgene and a second transgene, the first transgene providing increased tolerance or resistance to at least one Coleopteran pest and the second transgene providing resistance to at least one Lepidopteran pest, providing seed of a second transgenic pest resistant crop, the second transgenic pest resistant crop expressing a third transgene, the third transgene providing resistance to the same at least one Lepidopteran pest through a different mode of pesticidal action than the second transgene, and planting the seed of the first transgenic pest resistant crop and the seed of the second transgenic pest resistant crop in a plot. The seeds may further incorporate a herbicide resistance gene.

### DETAILED DESCRIPTION

In the description that follows, a number of terms are used extensively. The following definitions are provided to facilitate understanding of the invention.

The article “a” and “an” are used herein to refer to one or more than one (i.e., to at least one) of the grammatical object of the article. By way of example, “an element” means one or more element. As used herein, the term “comprising” means “including but not limited to.”

A “plot” is intended to mean an area where crops are planted of whatever size. As used herein, the term “transgenic pest resistant crop plant” means a plant or progeny thereof (including seeds) derived from a transformed plant cell or protoplast, wherein the plant DNA contains an introduced heterologous DNA molecule, not originally present in a native, non-transgenic plant of the same strain, that confers resistance to one or more corn rootworms. The term refers to the original transformant and progeny of the transformant that include the heterologous DNA. The term also refers to progeny produced by a sexual outcross between the transformant and another variety that includes the heterologous DNA. It is also to be understood that two different transgenic plants can also be mated to produce offspring that contain two or more independently segregating, added, heterologous genes. Selfing of appropriate progeny can produce plants that are homozygous for both added, heterologous genes. Back-crossing to a parental plant and out-crossing with a non-transgenic plant are also contemplated, as is vegetative propagation. Descriptions of other breeding methods that are commonly used for different traits and crop plants can be found in one of several references, e.g., Fehr (1987), in Breeding Methods for Cultivar Development, ed. J. Wilcox (American Society of Agronomy, Madison, Wisc.). Breeding methods can also be used to transfer any natural resistance genes into crop plants.

As used herein, the term “corn” means Zea mays or maize and includes all plant varieties that can be bred with corn, including wild maize species. In one embodiment, the disclosed methods are useful for managing resistance in a plot of pest resistant corn, where corn is systematically followed by corn (i.e., continuous corn). In another embodiment, the methods are useful for managing resistance in a plot of first-year pest resistant corn, that is, where corn is followed by another crop (e.g., soybeans), in a two-year rotation cycle. Other rotation cycles are also contemplated in the context of the invention, for example where corn is followed by multiple years of one or more other crops, so as to prevent resistance in other extended diapause pests that may develop over time.

A crop is considered to have a “high dose” of a pesticidal agent if it has or produces at least about 25 times the concentration of pesticidal agent (such as, for example, Bt protein) necessary to kill susceptible larvae. For example, in the context of Bt crops, Bt cultivars must produce a high enough toxin concentration to kill nearly all of the insects that are heterozygous for resistance, assuming, of course, that a single gene can confer resistance to the particular Bt protein or other toxin. Currently, a Bt plant-incorporated protectant is generally considered to provide a high dose if verified by at least two of the following five approaches: 1) Serial dilution bioassay with artificial diet containing lyophilized tissues of Bt plants using tissues from non-Bt plants as controls; 2) Bioassays using plant lines with expression levels approximately 25-fold lower than the commercial cultivar determined by quantitative ELISA or some more reliable technique; 3) Survey large numbers of commercial plants in the field to make sure that the cultivar is at the LD_{99.9} or higher to assure that 95% of heterozygotes would be killed (see Andow & Hutchison 1998); 4) Similar to #3 above, but would use controlled infestation with a laboratory strain of the pest that had an LD₅₀ value similar to field strains; and 5) Determine if a later larval instar of the targeted pest could be found with an LD₅₀ that was about 25-fold higher than that of the neonate larvae. If so, the later stage could be tested on the Bt crop plants to determine if 95% or more of the later stage larvae were killed.

The current knowledge base for high dose expression is summarized in the following table:

TABLE 2

| | SEASON-LONG HIGH DOSE FOR CORN PESTS | | | | | |
|---|---|---|---|---|---|---|
| HYBRID | ECB | CEW | SWCB | FAW | SCSB | CSB |
| Bt11 | Probable | No | Unknown | No | Unknown | Unknown |
| Bt Sweet | Probable | No | Unknown | No | Unknown | Unknown |
| Corn | | | | | | |
| (BT11) | | | | | | |
| MON 810 | Yes | No | Unknown | No | Unknown | Unknown |
| TC1507 | Yes | No | | | | |

As used herein, the term “polypeptide,” “peptide,” and “protein” are used interchangeably herein to refer to a polymer of amino acid residues. The terms apply to amino acid polymers in which one or more amino acid residues is an artificial chemical analogue of a corresponding naturally-occurring amino acid, as well as to naturally-occurring amino acid polymers.

As used herein, the terms “pesticidal activity” and “insecticidal activity” are used synonymously to refer to activity of an organism or a substance (such as, for example, a protein) that can be measured, by way of non-limiting example, via pest mortality, retardation of pest development, pest weight loss, pest repellency, and other behavioral and physical changes of a pest after feeding and exposure for an appropriate length of time. In this manner, pesticidal activity often impacts at least one measurable parameter of pest fitness. For example, the pesticide may be a polypeptide to decrease or inhibit insect feeding and/or to increase insect mortality upon ingestion of the polypeptide. Assays for assessing pesticidal activity are well known in the art. See, e.g., U.S. Pat. Nos. 6,570,005 and 6,339,144.

As used herein, the term “Pesticidal gene” or “pesticidal polynucleotide” refers to a nucleotide sequence that encodes a polypeptide that exhibits pesticidal activity. As used herein, the terms “pesticidal polypeptide,” “pesticidal protein,” or “insect toxin” is intended to mean a protein having pesticidal activity.

As used herein, the term “pesticidal” is used to refer to a toxic effect against a pest (e.g., CRW), and includes activity of either, or both, an externally supplied pesticide and/or an agent that is produced by the crop plants. As used herein, the term “different mode of pesticidal action” includes the pesticidal effects of one or more resistance traits, whether introduced into the crop plants by transformation or traditional breeding methods, such as binding of a pesticidal toxin produced by the crop plants to different binding sites (i.e., different toxin receptors and/or different sites on the same toxin receptor) in the gut membranes of corn rootworms. With regard to modes of pesticidal action, pesticidal compounds bind “competitively” if they have identical binding sites in the pest with no binding sites that one compound will bind that the other will not bind. For example, if compound A uses binding sites 1 and 2 only, and compound B also uses binding sites 1 and 2 only, compounds A and B bind “competitively.” Pesticidal compounds bind “semi-competitively” if they have at least one common binding site in the pest, but also at least one binding site not in common. For example, if compound C uses binding sites 3 and 4, and compound D uses only binding site 3, compounds C and D bind “semi-competitively.” Pesticidal compounds bind “non-competitively” if they have no binding sites in common in the pest. For example, if compound E uses binding sites 5 and 6, and compound F uses binding site 7, compounds E and F bind “non-competitively.”

As used herein, the term “pesticidally effective amount” connotes a quantity of a substance or organism that has pesticidal activity when present in the environment of a pest. For each substance or organism, the pesticidally effective amount is determined empirically for each pest affected in a specific environment. Similarly an “insecticidally effective amount” may be used to refer to an “pesticidally effective amount” when the pest is an insect pest.

An “insecticidal composition” is intended to mean that the compositions of embodiments of the invention have activity against plant insect pathogens; including insect pests of the order Homoptera, and thus is capable of suppressing, controlling, and/or killing the invading insect. An insecticidal composition of the embodiments of the invention will reduce the symptoms resulting from insect challenge by at least about 5% to about 50%, at least about 10% to about 60%, at least about 30% to about 70%, at least about 40% to about 80%, or at least about 50% to about 90% or greater. Hence, the methods of the embodiments of the invention can be utilized to protect organisms, particularly plants, from invading insects.

As used herein, the term “improved insecticidal activity” characterizes a δ-endotoxin of the invention that either has enhanced anti-Coleopteran pesticidal activity relative to the activity of its corresponding wild-type protein, and/or an endotoxin that is effective against either a broader range of insects, or acquires a specificity for an insect that is not susceptible to the toxicity of the wild-type protein. A finding of enhanced pesticidal activity requires a demonstration of an increase of toxicity of at least 30% against the insect target, and more preferably 35%, 40%, 45%, or 50% relative to the insecticidal activity of the wild-type endotoxin determined against the same insect.

As used herein, the term “transgenic” includes any cell, cell line, callus, tissue, plant part, or plant, the genotype of which has been altered by the presence of heterologous nucleic acid including those transgenics initially so altered as well as those created by sexual crosses or asexual propagation from the initial transgenic. The term “transgenic” as used herein does not encompass the alteration of the genome (chromosomal or extra-chromosomal) by conventional plant breeding methods or by naturally occurring events such as random cross-fertilization, non-recombinant viral infection, non-recombinant bacterial transformation, non-recombinant transposition, or spontaneous mutation.

As used herein, the term “plant” includes reference to whole plants, plant organs (e.g., leaves, stems, roots, etc.), seeds, plant cells, plant protoplasts, plant cell tissue cultures from which plants can be regenerated, plant calli, plant clumps, and plant cells that are intact in plants or parts of plants and progeny of same. Parts of transgenic plants are to be understood within the scope of the invention to comprise, for example, plant cells, protoplasts, tissues, callus, embryos as well as flowers, pollen, ovules, seeds, branches, kernels, ears, cobs, husks, stalks, stems, fruits, leaves, roots, root tips, anthers, and the like, originating in transgenic plants or their progeny previously transformed with a DNA molecule of the invention and therefore consisting at least in part of transgenic cells, are also an object of the present invention. Grain is intended to mean the mature seed produced by commercial growers for purposes other than growing or reproducing the species. Progeny, variants, and mutants of the regenerated plants are also included within the scope of the invention, provided that these parts comprise the introduced polynucleotides.

As used herein, the term “plant cell” includes, without limitation, seeds, suspension cultures, embryos, meristematic regions, callus tissue, leaves, roots, shoots, gametophytes, sporophytes, pollen, and microspores. The class of plants that can be used in the methods of the invention is generally as broad as the class of higher plants amenable to transformation techniques, including both monocotyledonous and dicotyledonous plants.

As used herein, the term “creating or enhancing insect resistance” is intended to mean that the plant, which has been genetically modified in accordance with the methods of the present invention, has increased resistance to one or more insect pests relative to a plant having a similar genetic component with the exception of the genetic modification described herein. Genetically modified plants of the present invention are capable of expression of at least one insecticidal lipase and at least one Bt insecticidal protein, the combination of which protects a plant from an insect pest while impacting an insect pest of a plant. “Protects a plant from an insect pest” is intended to mean the limiting or eliminating of insect pest-related damage to a plant by, for example, inhibiting the ability of the insect pest to grow, feed, and/or reproduce or by killing the insect pest. As used herein, “impacting an insect pest of a plant” includes, but is not limited to, deterring the insect pest from feeding further on the plant, harming the insect pest by, for example, inhibiting the ability of the insect to grow, feed, and/or reproduce, or killing the insect pest.

As used herein, the term “insecticidal lipase” is used in its broadest sense and includes, but is not limited to, any member of the family of lipid acyl hydrolases that has toxic or inhibitory effects on insects. Also, the term “Bt insecticidal protein” is used in its broadest sense and includes, but is not limited to, any member of the family of Bacillus thuringiensis proteins that have toxic or inhibitory effects on insects, such as Bt toxins described herein and known in the art, and includes, for example, the vegetative insecticidal proteins and the δ-endotoxins or cry toxins. It further includes any modified forms of Bt toxins, such as chimeric toxins, shuffled toxins, or the like. Thus, as described herein, insect resistance can be conferred to an organism by introducing a nucleotide sequence encoding an insecticidal lipase with a sequence encoding a Bt insecticidal protein or applying an insecticidal substance, which includes, but is not limited to, an insecticidal protein, to an organism (e.g., a plant or plant part thereof).

As used herein, “mixing” seeds means, for example, mixing at least two types of seeds in a bag (such as during packaging, production, or sale), mixing at least two types of seeds in a plot, or any other method that results in at least two types of seeds being introduced into plot. The mixture could result in a random arrangement in the plot, or could be in the context of a structured refuge of some type (such as, for example, a block refuge or strip refuge). When a structured refuge is used, a “plot” as used herein may, but does not necessarily, include such structured refuge.

Those skilled in the art will recognize that not all compounds are equally effective against all pests. Compounds of the embodiments display activity against insect pests, which may include economically important agronomic, forest, greenhouse, nursery, ornamentals, food and fiber, public and animal health, domestic and commercial structure, household, and stored product pests. Insect pests include insects selected from the orders Coleoptera, Diptera, Hymenoptera, Lepidoptera, Mallophaga, Homoptera, Hemiptera, Orthoptera, Thysanoptera, Dermaptera, Isoptera, Anoplura, Siphonaptera, Trichoptera, etc., particularly Coleoptera and Lepidoptera.

### Coleoptera

Of interest are larvae and adults of the order Coleoptera including weevils from the families Anthribidae, Bruchidae, and Curculionidae (including, but not limited to: Anthonomus grandis Boheman (boll weevil); Lissorhoptrus oryzophilus Kuschel (rice water weevil); Sitophilus granarius Linnaeus (granary weevil); S. oryzae Linnaeus (rice weevil); Hypera punctata Fabricius (clover leaf weevil); Cylindrocopturus adspersus LeConte (sunflower stem weevil); Smicronyx fulvus LeConte (red sunflower seed weevil); S. sordidus LeConte (gray sunflower seed weevil); Sphenophorus maidis Chittenden (maize billbug)); flea beetles, cucumber beetles, rootworms, leaf beetles, potato beetles, and leafminers in the family Chrysomelidae (including, but not limited to: Leptinotarsa decemlineata Say (Colorado potato beetle); Diabrotica virgifera virgifera LeConte (western corn rootworm); D. barberi Smith & Lawrence (northern corn rootworm); D. undecimpunctata howardi Barber (southern corn rootworm); Chaetocnema pulicaria Melsheimer (corn flea beetle); Phyllotreta cruciferae Goeze (corn flea beetle); Colaspis brunnea Fabricius (grape colaspis); Oulema melanopus Linnaeus (cereal leaf beetle); Zygogramma exciamationis Fabricius (sunflower beetle)); beetles from the family Coccinellidae (including, but not limited to: Epilachna varivestis Mulsant (Mexican bean beetle)); chafers and other beetles from the family Scarabaeidae (including, but not limited to: Popillia japonica Newman (Japanese beetle); Cyclocephala borealis Arrow (northern masked chafer, white grub), C. immaculata Olivier (southern masked chafer, white grub); Rhizotrogus majalis Razoumowsky (European chafer); Phyllophaga crinita Burmeister (white grub); Ligyrus gibbosus De Geer (carrot beetle)); carpet beetles from the family Dermestidae; wireworms from the family Elateridae, Eleodes spp., Melanotus spp.; Conoderus spp.; Limonius spp.; Agriotes spp.; Ctenicera spp.; Aeolus spp.; bark beetles from the family Scolytidae and beetles from the family Tenebrionidae.

### Diptera

Adults and immatures of the order Diptera are of interest, including leafminers Agromyza parvicornis Loew (corn blotch leafminer); midges (including, but not limited to: Contarinia sorghicola Coquillett (sorghum midge); Mayetiola destructor Say (Hessian fly); Sitodiplosis mosellana Géhin (wheat midge); Neolasioptera murtfeldtiana Felt, (sunflower seed midge)); fruit flies (Tephritidae), Oscinella frit Linnaeus (frit flies); maggots (including, but not limited to: Delia platura Meigen (seedcorn maggot); D. coarctata Fallen (wheat bulb fly); and other Delia spp., Meromyza americana Fitch (wheat stem maggot); Musca domestica Linnaeus (house flies); Fannia canicularis Linnaeus, F. femoralis Stein (lesser house flies); Stomoxys calcitrans Linnaeus (stable flies)); face flies, horn flies, blow flies, Chrysomya spp.; Phormia spp.; and other muscoid fly pests, horse flies Tabanus spp.; bot flies Gastrophilus spp.; Oestrus spp.; cattle grubs Hypoderma spp.; deer flies Chrysops spp.; Melophagus ovinus Linnaeus (keds); and other Brachycera, mosquitoes Aedes spp.; Anopheles spp.; Culex spp.; black flies Prosimulium spp.; Simulium spp.; biting midges, sand flies, sciarids, and other Nematocera.

### Hymenoptera

Insect pests of the order Hymenoptera are also of interest, including sawflies such as Cephus cinctus Norton (wheat stem sawfly); ants (including, but not limited to: Camponotus ferrugineus Fabricius (red carpenter ant); C. pennsylvanicus De Geer (black carpenter ant); Monomorium pharaonis Linnaeus (Pharaoh ant); Wasmannia auropunctata Roger (little fire ant); Solenopsis geminata Fabricius (fire ant); S. molesta Say (thief ant); S. invicta Buren (red imported fire ant); Iridomyrmex humilis Mayr (Argentine ant); Paratrechina longicornis Latreille (crazy ant); Tetramorium caespitum Linnaeus (pavement ant); Lasius alienus Förster (cornfield ant); Tapinoma sessile Say (odorous house ant)); bees (including carpenter bees), hornets, yellow jackets and wasps.

### Lepidoptera

Larvae of the order Lepidoptera include, but are not limited to, armyworms, cutworms, loopers, and heliothines in the family Noctuidae Spodoptera frugiperda J E Smith (fall armyworm); S. exigua Hübner (beet armyworm); S. litura Fabricius (tobacco cutworm, cluster caterpillar); Mamestra configurata Walker (bertha armyworm); M. brassicae Linnaeus (cabbage moth); Agrotis ipsilon Hufnagel (black cutworm); A. orthogonia Morrison (pale western cutworm); A. subterranea Fabricius (granulate cutworm); Alabama argillacea Hübner (cotton leaf worm); Trichoplusia ni Hübner (cabbage looper); Pseudoplusia includens Walker (soybean looper); Anticarsia gemmatalis Hübner (velvetbean caterpillar); Hypena scabra Fabricius (green cloverworm); Heliothis virescens Fabricius (tobacco budworm); Pseudaletia unipuncta Haworth (armyworm); Athetis mindara Barnes and Mcdunnough (rough skinned cutworm); Euxoa messoria Harris (darksided cutworm); Earias insulana Boisduval (spiny bollworm); E. vittella Fabricius (spotted bollworm); Helicoverpa armigera Hübner (American bollworm); H. zea Boddie (corn earworm or cotton bollworm); Melanchra picta Harris (zebra caterpillar); Egira (Xylomyges) curialis Grote (citrus cutworm); borers, casebearers, webworms, coneworms, and skeletonizers from the family Crambidae Ostrinia nubilalis Hübner (European corn borer); Chilo suppressalis Walker (rice stem borer); C. partellus, (sorghum borer); Crambus caliginosellus Clemens (corn root webworm); C. teterrellus Zincken (bluegrass webworm); Desmia funeralis Hübner (grape leaffolder); Diaphania hyalinata Linnaeus (melon worm); D. nitidalis Stoll (pickleworm); Diatraea grandiosella Dyar (southwestern corn borer), D. saccharalis Fabricius (surgarcane borer); Eoreuma loftini Dyar (Mexican rice borer); Herpetogramma licarsisalis Walker (sod webworm); Loxostege sticticalis Linnaeus (beet webworm); Maruca testulalis Geyer (bean pod borer); Udea rubigalis Guenée (celery leaftier); Pyralidae Amyelois transitella Walker (naval orangeworm); Anagasta kuehniella Zeller (Mediterranean flour moth); Cadra cautella Walker (almond moth); Corcyra cephalonica Stainton (rice moth); Cnaphalocrocis medinalis Guenëe (rice leaf roller); Ephestia elutella Hübner (tobacco (cacao) moth); Galleria mellonella Linnaeus (greater wax moth); Homoeosoma electellum Hulst (sunflower moth); Elasmopalpus lignosellus Zeller (lesser cornstalk borer); Achroia grisella Fabricius (lesser wax moth); Orthaga thyrisalis Walker (tea tree web moth); Plodia interpunctella Hübner (Indian meal moth); and leafrollers, budworms, seed worms, and fruit worms in the family Tortricidae Acleris gloverana Walsingham (Western blackheaded budworm); A. variana Fernald (Eastern blackheaded budworm); Archips argyrospila Walker (fruit tree leaf roller); A. rosana Linnaeus (European leaf roller); and other Archips species, Adoxophyes orana Fischer von Rösslerstamm (summer fruit tortrix moth); Cochylis hospes Walsingham (banded sunflower moth); Cydia latiferreana Walsingham (filbertworm); C. pomonella Linnaeus (coding moth); Platynota flavedana Clemens (variegated leafroller); P. stultana Walsingham (omnivorous leafroller); Lobesia botrana Denis & Schiffermüller (European grape vine moth); Spilonota ocellana Denis & Schiffermüller (eyespotted bud moth); Endopiza viteana Clemens (grape berry moth); Eupoecilia ambiguella Hübner (vine moth); Bonagota salubricola Meyrick (Brazilian apple leafroller); Grapholita molesta Busek (oriental fruit moth); Suleima helianthana Riley (sunflower bud moth); Argyrotaenia spp.; Choristoneura spp.

Selected other agronomic pests in the order Lepidoptera include, but are not limited to, Alsophila pometaria Harris (fall cankerworm); Anarsia lineatella Zeller (peach twig borer); Anisota senatoria J. E. Smith (orange striped oakworm); Antheraea pernyi Guérin-Méneville (Chinese Oak Silkmoth); Bombyx mori Linnaeus (Silkworm); Bucculatrix thurberiella Busck (cotton leaf perforator); Colias eurytheme Boisduval (alfalfa caterpillar); Datana integerrima Grote & Robinson (walnut caterpillar); Dendrolimus sibiricus Tschetwerikov (Siberian silk moth), Ennomos subsignaria Hübner (elm spanworm); Erannis tiliaria Harris (linden looper); Euproctis chrysorrhoea Linnaeus (browntail moth); Harrisina americana Guérin-Méneville (grapeleaf skeletonizer); Hemileuca oliviae Cockrell (range caterpillar); Hyphantria cunea Drury (fall webworm); Keiferia lycopersicella Walsingham (tomato pinworm); Lambdina fiscellaria fiscellaria Hulst (Eastern hemlock looper); L. fiscellaria lugubrosa Hulst (Western hemlock looper); Leucoma salicis Linnaeus (satin moth); Lymantria dispar Linnaeus (gypsy moth); Manduca quinquemaculata Haworth (five spotted hawk moth, tomato hornworm); M. sexta Haworth (tomato hornworm, tobacco hornworm); Operophtera brumata Linnaeus (winter moth); Paleacrita vernata Peck (spring cankerworm); Papilio cresphontes Cramer (giant swallowtail, orange dog); Phryganidia californica Packard (California oakworm); Phyllocnistis citrella Stainton (citrus leafminer); Phyllonorycter blancardella Fabricius (spotted tentiform leafminer); Pieris brassicae Linnaeus (large white butterfly); P. rapae Linnaeus (small white butterfly); P. napi Linnaeus (green veined white butterfly); Platyptilia carduidactyla Riley (artichoke plume moth); Plutella xylostella Linnaeus (diamondback moth); Pectinophora gossypiella Saunders (pink bollworm); Pontia protodice Boisduval & Leconte (Southern cabbageworm); Sabulodes aegrotata Guenée (omnivorous looper); Schizura concinna J. E. Smith (red humped caterpillar); Sitotroga cerealella Olivier (Angoumois grain moth); Thaumetopoea pityocampa Schiffermuller (pine processionary caterpillar); Tineola bisselliella Hummel (webbing clothesmoth); Tuta absoluta Meyrick (tomato leafminer); Yponomeuta padella Linnaeus (ermine moth); Heliothis subflexa Guenée; Malacosoma spp. and Orgyia spp.

### Mallophaga

Insect pests of the order Mallophaga are also of interest, and include Pediculus humanus capitis De Geer (head louse); P. humanus humanus Linnaeus (body louse); Menacanthus stramineus Nitzsch (chicken body louse); Trichodectes canis De Geer (dog biting louse); Goniocotes gallinae De Geer (fluff louse); Bovicola ovis Schrank (sheep body louse); Haematopinus eurysternus Nitzsch (short-nosed cattle louse); Linognathus vituli Linnaeus (long-nosed cattle louse); and other sucking and chewing parasitic lice that attack man and animals.

### Homoptera & Hemiptera

Included as insects of interest are adults and nymphs of the orders Hemiptera and Homoptera such as, but not limited to, adelgids from the family Adelgidae, plant bugs from the family Miridae, cicadas from the family Cicadidae, leafhoppers, Empoasca spp.; from the family Cicadellidae, planthoppers from the families Cixiidae, Flatidae, Fulgoroidea, Issidae and Delphacidae, treehoppers from the family Membracidae, psyllids from the family Psyllidae, whiteflies from the family Aleyrodidae, aphids from the family Aphididae, phylloxera from the family Phylloxeridae, mealybugs from the family Pseudococcidae, scales from the families Asterolecanidae, Coccidae, Dactylopiidae, Diaspididae, Eriococcidae, Ortheziidae, Phoenicococcidae and Margarodidae, lace bugs from the family Tingidae, stink bugs from the family Pentatomidae, cinch bugs, Blissus spp.; and other seed bugs from the family Lygaeidae, spittlebugs from the family Cercopidae squash bugs from the family Coreidae, and red bugs and cotton stainers from the family Pyrrhocoridae.

Agronomically important members from the order Homoptera further include, but are not limited to: Acyrthisiphon pisum Harris (pea aphid); Aphis craccivora Koch (cowpea aphid); A. fabae Scopoli (black bean aphid); A. gossypii Glover (cotton aphid, melon aphid); A. maidiradicis Forbes (corn root aphid); A. pomi De Geer (apple aphid); A. spiraecola Patch (spirea aphid); Aulacorthum solani Kaltenbach (foxglove aphid); Chaetosiphon fragaefolii Cockerell (strawberry aphid); Diuraphis noxia Kurdjumov/Mordvilko (Russian wheat aphid); Dysaphis plantaginea Paaserini (rosy apple aphid); Eriosoma lanigerum Hausmann (woolly apple aphid); Brevicoryne brassicae Linnaeus (cabbage aphid); Hyalopterus pruni Geoffroy (mealy plum aphid); Lipaphis erysimi Kaltenbach (turnip aphid); Metopolophium dirrhodum Walker (cereal aphid); Macrosiphum euphorbiae Thomas (potato aphid); Myzus persicae Sulzer (peach-potato aphid, green peach aphid); Nasonovia ribisnigri Mosley (lettuce aphid); Pemphigus spp. (root aphids and gall aphids); Rhopalosiphum maidis Fitch (corn leaf aphid); R. padi Linnaeus (bird cherry-oat aphid); Schizaphis graminum Rondani (greenbug); Sipha flava Forbes (yellow sugarcane aphid); Sitobion avenae Fabricius (English grain aphid); Therioaphis maculata Buckton (spotted alfalfa aphid); Toxoptera aurantii Boyer de Fonscolombe (black citrus aphid); and T. citricida Kirkaldy (brown citrus aphid); Adelges spp. (adelgids); Phylloxera devastatrix Pergande (pecan phylloxera); Bemisia tabaci Gennadius (tobacco whitefly, sweetpotato whitefly); B. argentifolii Bellows & Perring (silverleaf whitefly); Dialeurodes citri Ashmead (citrus whitefly); Trialeurodes abutiloneus (bandedwinged whitefly) and T. vaporariorum Westwood (greenhouse whitefly); Empoasca fabae Harris (potato leafhopper); Laodelphax striatellus Fallen (smaller brown planthopper); Macrolestes quadrilineatus Forbes (aster leafhopper); Nephotettix cinticeps Uhler (green leafhopper); N. nigropictus Stål (rice leafhopper); Nilaparvata lugens Stål (brown planthopper); Peregrinus maidis Ashmead (corn planthopper); Sogatella furcifera Horvath (white-backed planthopper); Sogatodes orizicola Muir (rice delphacid); Typhlocyba pomaria McAtee (white apple leafhopper); Erythroneoura spp. (grape leafhoppers); Magicicada septendecim Linnaeus (periodical cicada); Icerya purchasi Maskell (cottony cushion scale); Quadraspidiotus perniciosus Comstock (San Jose scale); Planococcus citri Risso (citrus mealybug); Pseudococcus spp. (other mealybug complex); Cacopsylla pyricola Foerster (pear psylla); Trioza diospyri Ashmead (persimmon psylla).

Agronomically important species of interest from the order Hemiptera include, but are not limited to: Acrosternum hilare Say (green stink bug); Anasa tristis De Geer (squash bug); Blissus leucopterus leucopterus Say (chinch bug); Corythuca gossypii Fabricius (cotton lace bug); Cyrtopeltis modesta Distant (tomato bug); Dysdercus suturellus Herrich-Schäffer (cotton stainer); Euschistus servus Say (brown stink bug); Euschistus variolarius Palisot de Beauvois (one-spotted stink bug); Graptostethus spp. (complex of seed bugs); Leptoglossus corculus Say (leaf-footed pine seed bug); Lygus lineolaris Palisot de Beauvois (tarnished plant bug); Lygus Hesperus Knight (Western tarnished plant bug); Lygus pratensis Linnaeus (common meadow bug); Lygus rugulipennis Poppius (European tarnished plant bug); Lygocoris pabulinus Linnaeus (common green capsid); Nezara viridula Linnaeus (southern green stink bug); Oebalus pugnax Fabricius (rice stink bug); Oncopeltus fasciatus Dallas (large milkweed bug); Pseudatomoscelis seriatus Reuter (cotton fleahopper).

Furthermore, embodiments of the present invention may be effective against Hemiptera such, Calocoris norvegicus Gmelin (strawberry bug); Orthops campestris Linnaeus; Plesiocoris rugicollis Fallen (apple capsid); Cyrtopeltis modestus Distant (tomato bug); Cyrtopeltis notatus Distant (suckfly); Spanagonicus albofasciatus Reuter (whitemarked fleahopper); Diaphnocoris chlorionis Say (honeylocust plant bug); Labopidicola allii Knight (onion plant bug); Pseudatomoscelis seriatus Reuter (cotton fleahopper); Adelphocoris rapidus Say (rapid plant bug); Poecilocapsus lineatus Fabricius (four-lined plant bug); Nysius ericae Schilling (false chinch bug); Nysius raphanus Howard (false chinch bug); Nezara viridula Linnaeus (Southern green stink bug); Eurygaster spp., Coreidae spp.; Pyrrhocoridae spp.; Tinidae spp.; Blostomatidae spp., Reduviidae spp.; and Cimicidae spp.

### Orthoptera

Adults and immatures of the insect order Orthoptera are of interest, including grasshoppers, locusts and crickets Melanoplus sanguinipes Fabricius (migratory grasshopper); M. differentialis Thomas (differential grasshopper); M. femurrubrum De Geer, (redlegged grasshopper); Schistocerca americana Drury (American grasshopper); S. gregaria Forskal (desert locust); Locusta migratoria Linnaeus (migratory locust); Acheta domesticus Linnaeus (house cricket); and Gryllotalpa spp. (mole crickets).

### Thysanoptera

Adults and immatures of the order Thysanoptera are of interest, including Thrips tabaci Lindeman (onion thrips); Anaphothrips obscrurus Müller (grass thrips); Frankliniella fusca Hinds (tobacco thrips); Frankliniella occidentalis Pergande (western flower thrips); Neohydatothrips variabilis Beach (soybean thrips); Scirthothrips citri Moulton (citrus thrips); and other foliar feeding thrips.

### Dermaptera

Further insects of interest include adults and larvae of the order Dermaptera including earwigs from the family Forficulidae, Forficula auricularia Linnaeus (European earwig); Chelisoches morio Fabricius (black earwig).

### Trichoptera

Other insects of interest include nymphs and adults of the order Blattodea including cockroaches from the families Blattellidae and Blattidae, Blatta orientalis Linnaeus (oriental cockroach); Blattella asahinai Mizukubo (Asian cockroach); Blattella germanica Linnaeus (German cockroach); Supella longipalpa Fabricius (brownbanded cockroach); Periplaneta americana Linnaeus (American cockroach); Periplaneta brunnea Burmeister (brown cockroach); Leucophaea maderae Fabricius (Madeira cockroach).

Also included are adults and larvae of the order Acari (mites) such as Aceria tosichella Keifer (wheat curl mite); Petrobia latens Müller (brown wheat mite); spider mites and red mites in the family Tetranychidae, Panonychus ulmi Koch (European red mite); Tetranychus urticae Koch (two spotted spider mite); (T. mcdanieli McGregor (McDaniel mite); T. cinnabarinus Boisduval (carmine spider mite); T. turkestani Ugarov & Nikolski (strawberry spider mite); flat mites in the family Tenuipalpidae, Brevipalpus lewisi McGregor (citrus flat mite); rust and bud mites in the family Eriophyidae and other foliar feeding mites and mites important in human and animal health, i.e. dust mites in the family Epidermoptidae, follicle mites in the family Demodicidae, grain mites in the family Glycyphagidae, ticks in the order Ixodidae. Ixodes scapularis Say (deer tick); Ixodes holocyclus Neumann (Australian paralysis tick); Dermacentor variabilis Say (American dog tick); Amblyomma americanum Linnaeus (lone star tick); and scab and itch mites in the families Psoroptidae, Pyemotidae, and Sarcoptidae.

Insect pests of the order Thysanura are of interest, such as Lepisma saccharina Linnaeus (silverfish); Thermobia domestica Packard (firebrat).

Exemplary embodiments of the invention utilize different modes of pesticidal action to avoid development of resistance in, for example, corn rootworms. Resistance to rootworms can be introduced into the crop plant by any method known in the art. In some embodiments, the different modes of pesticidal action include toxin binding to different binding sites in the gut membranes of the corn rootworms. Transgenes in the present invention useful against rootworms include, but are not limited to, those encoding Bt proteins. Other transgenes appropriate for other pests are also discussed herein and are known in the art.

In some embodiments of the invention, the method of introducing resistance comprises introducing a pesticidal gene into the plant. A non-limiting example of such a gene is a gene that encodes a Bt toxin, such as a homologue of a known Cry toxin. “Bt toxin” is intended to mean the broader class of toxins found in various strains of Bt, which includes such toxins as, for example, the vegetative insecticidal proteins and the δ-endotoxins. See, e.g., Crickmore et al. (1998) Microbiol. Molec. Biol. Rev. 62:807-813; Crickmore et al. (2004) Bacillus Thuringiensis Toxin Nomenclature at lifesci.sussex.ac.uk/Home/Neil_Crickmore/Bt. The vegetative insecticidal proteins (for example, members of the VIP1, VIP2, or VIP3 classes) are secreted insecticidal proteins that undergo proteolytic processing by midgut insect fluids. They have pesticidal activity against a broad spectrum of Lepidopteran insects. See, e.g., U.S. Pat. No. 5,877,012. The Bt δ-endotoxins are toxic to larvae of a number of insect pests, including members of the Lepidoptera, Diptera, and Coleoptera orders. These insect toxins include, but are not limited to, the Cry toxins, including, for example, Cry1, Cry3, Cry5, Cry8, and Cry9.

In certain embodiments the plants produce more than one toxin, for example, via gene stacking. For example, DNA constructs in the plants of the embodiments may comprise any combination of stacked nucleotide sequences of interest in order to create plants with a desired trait. A “trait,” as used herein, refers to the phenotype derived from a particular sequence or groups of sequences. A single expression cassette may contain both a nucleotide encoding a pesticidal protein of interest, and at least one additional gene, such as a gene employed to increase or improve a desired quality of the transgenic plant. Alternatively, the additional gene(s) can be provided on multiple expression cassettes. The combinations generated can also include multiple copies of any one of the polynucleotides of interest.

For example, gene stacks in the plants of the embodiments may contain one or more polynucleotides encoding polypeptides having pesticidal and/or insecticidal activity, such as Bt toxic proteins (described in, for example, U.S. Pat. Nos. 5,188,960; 5,277,905; 5,366,892; 5,593,881; 5,625,136; 5,689,052; 5,691,308; 5,723,756; 5,747,450; 5,859,336; 6,023,013; 6,114,608; 6,180,774; 6,218,188; 6,342,660; and 7,030,295; U.S. Publication Nos. US20040199939 and US20060085870; WO2004086868; and Geiser et al. (1986) Gene 48:109) and Bt crystal proteins of the Cry34 and Cry35 classes (see, e.g., Schnepf et al. (2005) Appl. Environ. Microbiol. 71:1765-1774). Also contemplated for use in gene stacks are the vegetative insecticidal proteins (for example, members of the VIP1, VIP2, or VIP3 classes). See, e.g., U.S. Pat. Nos. 5,849,870; 5,877,012; 5,889,174; 5,990,383; 6,107,279; 6,137,033; 6,291,156; 6,429,360; U.S. Publication Nos. US200502 10545; US20040 133942; US20020078473.

The Bt δ-endotoxins or Cry toxins that could be used in gene stacks are well known in the art. See, e.g., U.S. Publication No. US20030177528. These toxins include Cry 1 through Cry42, Cyt 1 and 2, Cyt-like toxin, and the binary Bt toxins. There are currently over 250 known species of Bt δ-endotoxins with a wide range of specificities and toxicities. For an expansive list see Crickmore et al. (1998) Microbiol. Mol. Biol. Rev. 62:807-813, and for regular updates via the World Wide Web, see biols.susx.ac.uk/Home/Neil_Crickmore/Bt/index. The criteria for inclusion in this list is that the proteins have significant sequence similarity to one or more toxins within the nomenclature or be a Bacillus thuringiensis parasporal inclusion protein that exhibits pesticidal activity, or that it have some experimentally verifiable toxic effect to a target organism. In the case of binary Bt toxins, those skilled in the art recognize that two Bt toxins must be co-expressed to induce Bt insecticidal activity.

Specific, non-limiting examples of Bt Cry toxins of interest include the group consisting of Cry1 (such as Cry1A, Cry1A(a), Cry1A(b), Cry1A(c), Cry1C, Cry1D, Cry1E, Cry1F), Cry2 (such as Cry2A), Cry3 (such as Cry3Bb), Cry5, Cry8 (see GenBank Accession Nos. CAD57542, CAD57543, see also U.S. patent application Ser. No. 10/746,914), Cry9 (such as Cry9C) and Cry34/35, as well as functional fragments, chimeric or shuffled modifications, or other variants thereof.

Stacked genes in plants of the embodiments may also encode polypeptides having insecticidal activity other than Bt toxic proteins, such as lectins (Van Damme et al. (1994) Plant Mol. Biol. 24:825, pentin (described in U.S. Pat. No. 5,981,722), lipases (lipid acyl hydrolases, see, e.g., those disclosed in U.S. Pat. Nos. 6,657,046 and 5,743,477; see also WO2006131750A2), cholesterol oxidases from Streptomyces, and pesticidal proteins derived from Xenorhabdus and Photorhabdus bacteria species, Bacillus laterosporus species, and Bacillus sphaericus species, and the like. Also contemplated is the use of chimeric (hybrid) toxins (see, e.g., Bosch et al. (1994) Bio/Technology 12:915-918).

Such transformants can contain transgenes that are derived from the same class of toxin (e.g., more than one δ-endotoxin, more than one pesticidal lipase, more than one binary toxin, and the like), or the transgenes can be derived from different classes of toxins (e.g., a δ-endotoxin in combination with a pesticidal lipase or a binary toxin). For example, a plant having the ability to express an insecticidal δ-endotoxin derived from Bt (such as Cry1F), also has the ability to express at least one other δ-endotoxin that is different from the Cry1F protein, such as, for example, a Cry1A(b) protein. Similarly, a plant having the ability to express an insecticidal δ-endotoxin derived from Bt (such as Cry1F), also has the ability to express a pesticidal lipase, such as, for example, a lipid acyl hydrolase.

In practice, certain stacked combinations of the various Bt and other genes described previously are best suited for certain pests, based on the nature of the pesticidal action and the susceptibility of certain pests to certain toxins. For example, some transgenic combinations are particularly suited for use against various types of corn rootworm (CRW), including WCRW, northern corn rootworm (NCRW), and Mexican corn rootworm (MCRW). These combinations include at least Cry34/35 and Cry3A; and Cry34/35 and Cry3B. Other combinations are also known for other pests. For example, combinations appropriate for use against ECB and/or southwestern corn borer (SWCB) include at least Cry1Ab and Cry1F, Cry1Ab and Cry2, Cry1Ab and Cry9, Cry1Ab and Cry2/Vip3A stack, Cry1Ab and Cry1F/Vip3A stack, Cry1F and Cry2, Cry1F and Cry9, as well as Cry1F and Cry2/Vip3A stack. Combinations appropriate for use against corn earworm (CEW) include at least Cry1 Ab and Cry2, Cry1 F and Cry2, Cry1 Ab and Cry1 F, Cry2 and Vip3A, Cry1Ab and Cry2/Vip3A stack, Cry1Ab and Cry1F/Vip3A stack, as well as Cry1F and Cry2/Vip3A stack. Combinations appropriate for use against fall armyworm (FAW) include at least Cry1F and Cry1Ab, Cry1F and Vip3A, Cry1Ab and Cry1F/Vip3A stack, Cry1F and Cry2/Vip3A stack, and Cry1Ab and Cry2/Vip3A stack, Combinations appropriate for use against black cutworm (BCW) and/or western bean cutworm (WBCW) include Cry1F and Vip3A, Cry1F and Cry2, as well as Cry1F and Cry2/Vip3A stack. Also, these various combinations may be further combined with each other in order to provide resistance management to multiple pests.

The plants of the embodiments can also contain gene stacks containing a combination of genes to produce plants with a variety of desired trait combinations including, but not limited to, traits desirable for animal feed such as high oil genes (e.g., U.S. Pat. No. 6,232,529); balanced amino acids (e.g., hordothionins (U.S. Pat. Nos. 5,990,389; 5,885,801; 5,885,802; 5,703,049); barley high lysine (Williamson et al. (1987) Eur. J. Biochem. 165:99-106; WO 98/20122) and high methionine proteins (Pedersen et al. (1986) J. Biol Chem. 261:6279; Kirihara et al. (1988) Gene 71:359; Musumura et al. (1989) Plant Mol. Biol. 12:123)); increased digestibility (e.g., modified storage proteins (U.S. Pat. No. 6,858,778) and thioredoxins (U.S. Pat. No. 7,009,087)).

The plants of the embodiments can also contain gene stacks that comprise genes resulting in traits desirable for disease resistance (e.g., fumonisin detoxification genes (U.S. Pat. No. 5,792,931); avirulence and disease resistance genes (Jones et al. (1994) Science 266:789; Martin et al. (1993) Science 262:1432; Mindrinos et al. (1994) Cell 78:1089).

In further embodiments, the first and/or second pest resistant crop plant further contains a herbicide resistance gene that provides herbicide tolerance, for example, to glyphosate-N-(phosphonomethyl)glycine (including the isopropylamine salt form of such herbicide). Exemplary herbicide resistance genes include glyphosate N-acetyltransferase (GAT) and 5-enolpyruvylshikimate-3-phosphate synthase (EPSPS), including those disclosed in US Pat. Application Publication No. US20040082770, as well as WO02/36782 and WO03/092360). Herbicide resistance genes generally code for a modified target protein insensitive to the herbicide or for an enzyme that degrades or detoxifies the herbicide in the plant before it can act. See, e.g., DeBlock et al. (1987) EMBO J. 6:2513; DeBlock et al. (1989) Plant Physiol. 91:691; Fromm et al (1990) BioTechnology 8:833; Gordon-Kamm et al. (1990) Plant Cell 2:603; and Frisch et al. (1995) Plant Mol. Biol. 27:405-9. For example, resistance to glyphosate or sulfonylurea herbicides has been obtained using genes coding for the mutant target enzymes, EPSPS and acetolactate synthase (ALS). Resistance to glufosinate ammonium, bromoxynil, and 2,4-dichlorophenoxyacetate (2,4-D) have been obtained by using bacterial genes encoding phosphinothricin acetyltransferase, a nitrilase, or a 2,4-dichlorophenoxyacetate monooxygenase, which detoxify the respective herbicides. Also contemplated are inhibitors of glutamine synthase such as phosphinothricin or basta (e.g., bar gene).

Other plants of the embodiments may contain stacks comprising traits desirable for processing or process products such as modified oils (e.g., fatty acid desaturase genes (U.S. Pat. Nos. 5,952,544; 6,372,965)); modified starches (e.g., ADPG pyrophosphorylases (AGPase), starch synthases (SS), starch branching enzymes (SBE), and starch debranching enzymes (SDBE)); and polymers orbioplastics (e.g., U.S. Pat. No. 5,602,321; beta-ketothiolase, polyhydroxybutyrate synthase, and acetoacetyl-CoA reductase (Schubert et al. (1988) J. Bacteriol. 170:5837-5847)). One could also combine the polynucleotides of the embodiments with polynucleotides providing agronomic traits such as male sterility (e.g., see U.S. Pat. No. 5,583,210), stalk strength, flowering time, or transformation technology traits such as cell cycle regulation or gene targeting (e.g., WO 99/61619; U.S. Pat. Nos. 6,518,487 and 6,187,994).

These stacked combinations can be created by any method including, but not limited to, cross-breeding plants by any conventional or TopCross methodology, or genetic transformation. If the sequences are stacked by genetically transforming the plants, the polynucleotide sequences of interest can be combined at any time and in any order. For example, a transgenic plant comprising one or more desired traits can be used as the target to introduce further traits by subsequent transformation. The traits can be introduced simultaneously in a co-transformation protocol with the polynucleotides of interest provided by any combination of transformation cassettes. For example, if two sequences will be introduced, the two sequences can be contained in separate transformation cassettes (trans) or contained on the same transformation cassette (cis). Expression of the sequences can be driven by the same promoter or by different promoters. In certain cases, it may be desirable to introduce a transformation cassette that will suppress the expression of the polynucleotide of interest. This may be combined with any combination of other suppression cassettes or overexpression cassettes to generate the desired combination of traits in the plant. It is further recognized that polynucleotide sequences can be stacked at a desired genomic location using a site-specific recombination system. See, e.g., WO 99/25821, WO 99/25854, WO 99/25840, WO 99/25855, and WO 99/25853.

Given the currently-accepted understanding that a 20% refuge is appropriate for a single high dose insect resistance protein expression, it may be preferable, for at least regulatory reasons, to adopt something reasonably close to an 80%-20% mix of a first and second transgenic pest resistant seed. While the invention disclosed herein is not so limited, as depending on the characteristics of the pesticidal protein produced different mixes may be optimal for a particular pest, in general an 80-20 mix is thought to be reasonable in many cases when the pesticidal proteins are produced in high dose by the transgenic plants. Mixtures of seeds that target the same pest through a different mode of pesticidal action, however, are less likely to produce resistant insects, as it is highly unlikely that an insect will have resistance to both distinct modes of action. As a result, such cases lend themselves to different distributions other than an 80-20 mix (although it should be understood that the invention is not limited to a particular implementation or ratio).

In addition, pest resistance may be conferred via treatment of plant propagation material. Before plant propagation material (fruit, tuber, bulb, corn, grains, seed), but especially seed, is sold as a commercial product, it is customarily treated with a protectant coating comprising herbicides, insecticides, fungicides, bactericides, nematicides, molluscicides, or mixtures of several of these preparations, if desired together with further carriers, surfactants, or application-promoting adjuvants customarily employed in the art of formulation to provide protection against damage caused by bacterial, fungal, or animal pests. In order to treat the seed, the protectant coating may be applied to the seeds either by impregnating the tubers or grains with a liquid formulation or by coating them with a combined wet or dry formulation. In addition, in special cases, other methods of application to plants are possible, e.g., treatment directed at the buds or the fruit.

Further, native resistance genes can also be used in the present invention, such as maysin (Waiss, et al., J. Econ. Entomol. 72:256-258 (1979)); maize cysteine proteases, such as MIR1-CP, (Pechan, T. et al., Plant Cell 12:1031-40 (2000)); DIMBOA (Klun, J. A. et al., J. Econ. Entomol. 60:1529-1533 (1967)); and genes for husk tightness (Rector, B. G. et al., J. Econ. Entomol. 95:1303-1307 (2002)). Such genes may be used in the context of the plants in which they are found, or inserted to other plants via transgenic means as is known in the art and/or discussed herein.

Methods for managing pest resistance in a plot of pest resistant crop plants are provided. One such method includes cultivating a first pest resistant crop plant in a plot in one planting cycle, and cultivating in a second planting cycle a second pest resistant crop plant in the same plot, wherein the first and the second pest resistant crop plants are pesticidal to a target pest but through a different mode of pesticidal action. It is recognized that a resistance trait can be introduced into the crop plant by transformation (i.e., transgenic) or traditional breeding methods. Alternatively, an external pesticidal agent, such as a seed treatment or chemical pesticide may be used as one or both of the sources of pest resistance.

The method avoids the development of resistance in a target pest by killing resistant pests that are selected for in the first planting cycle during the second planting cycle. This is accomplished via the use of a source of pest resistance in the second planting cycle that acts via a different mode of action from the source of pest resistance in the first planting cycle. As a result, the likelihood that any resistant pests who survived the first planting cycle based on resistance to the first source of pest resistance will be killed during the second planting cycle, as resistance to the first source of pest resistance does not confer resistance to the second source of pest resistance because of the different mode of pesticidal action. Accordingly, unlike currently-accepted refuge requirements, an adequate refuge may be generated in a second planting cycle, making it possible from an IRM perspective to have a full crop of pest resistant plants in each planting cycle and still manage the development of resistance in pests.

Using this method of the invention, a grower can plant a corn crop in a plot the planting cycle following the cultivation of corn in the same plot. Prior to the invention, this was not advisable due to the risk of rootworm damage to the crop. Further, since recently there has been rootworm activity in other crops, the methods provide a means of controlling rootworm spread and a resistance management strategy for rootworms.

In a further embodiment, a method is provided to minimize or eliminate the necessity for a structured refuge in a plot, as currently is required as described previously. This is achieved through planting in a plot a mixture of seeds having resistance characteristics to target pests through different modes of action.

By way of non-limiting example, in corn, pests in the orders Lepidoptera and Coleoptera are often of interest, particularly pests such as CRW and ECB, as well as others previously described. Also as noted previously, it is advantageous for farmers to have as much of a crop as possible resistant to pests prevalent in a given area in order to maximize yield.

In order to have as many plants resistant to pests as possible while still managing resistance in the pests, plants in the plot are provided with more than one mechanism of pest resistance for at least one pest. For example, if it is desired to reduce or eliminate the necessity of a structured refuge for ECB, plants in the plot would be provided with at least two forms of pest resistance for ECB with different modes of action. In this regard, the possibility for development of resistant ECB pests is dramatically reduced, as the likelihood that a particular pest will have a necessary random mutation providing for resistance to both modes of pesticidal action would be remote. Non-limiting examples of combinations of sources of pest resistance that can be used in the context of the present invention have been described previously with regard to both ECB and other pests, and could include transgenes producing different Bt proteins (or other proteins providing such resistance), chemical pesticides, seed treatments, or a combination thereof. Particular pairs of Bt proteins with different modes of action have been described above.

Accordingly, plants exhibiting such first and second modes of pesticidal resistance would likely not require a separate structured refuge, or, at a minimum, would require a substantially smaller refuge. A smaller refuge would be acceptable because typically a refuge should produce about 500 susceptible insects for every resistant insect that survives exposure to the resistant crop. As the dual mode of action crop would produce substantially fewer (if any) surviving resistant insects, a correspondingly smaller number of susceptible insects would be needed from a refuge. As a result, this method is an effective way to reduce or eliminate the requirement for a refuge in a plant plot and still manage the development of resistant insects effectively.

Additionally, the same method may be employed for multiple pests in the same plot. For example, a plant may have resistance to both ECB and CRW via two modes of action through similar combinations listed above. If a plot comprises plants having resistance to two target pests, each via two different modes of action, the refuge for each of those pests should be able to be eliminated or reduced. As a result, the farmer no longer has to sacrifice yield in a portion of a planting in order to prevent insect resistance from developing. In addition, this method also prevents the compliance issues discussed previously where a farmer may, in the interest of increasing yield or simply through imperfect planting procedures, not plant a sufficient refuge to manage the development of resistant pests.

The disclosed methods may, for example, be used to delay the development of resistant insect pests in the orders Lepidoptera and Coleoptera, while increasing the total area of a plot still providing protection against crop damage caused by those pests. In a plot of pest resistant plants, this can be accomplished in multiple ways. For example, the plot may incorporate at least about 85%, 86%, 87%, 88%, 89%, 90%, 91%, 92%, 93%, 94%, 95%, 96%, 97%, 98%, or 99% plants producing Cry1A(b), Cry1F, and Cry34/35 proteins, with the remainder of the plants producing Cry1A(b) and Cry1F proteins. This results in 100% of the plants in the plot with resistance to at least one pest in order Lepidoptera, and an increased percentage of plants having resistance to at least one pest in order Coleoptera. This is possible because Cry1A(b) and Cry1F have different modes of action against Lepidopteran pests, and as such, having two modes of action against such pests means that only the very small number pests with resistance to both will survive in the plot. This means that little to no refuge is necessary to prevent the development of resistant pests, as the number of resistant pests is already very small. As such, the entirety of the crop planted in the plot exhibits resistance to at least one Lepidopteran pest. Different combinations of proteins may be used, as described herein, to target particular Lepidopteran pests that cause problems in a region of interest.

Additionally, a substantial majority of the plot is also protected from at least one Coleopteran pest. The nature of pests' reaction to Cry34/35 proteins (see U.S. Provisional Application 60/977,477) allows a greater percentage than the generally-accepted 80% of the plot to express those proteins while still having sufficient refuge for the Coleopteran pest(s) of interest. As a result, in such a system, the grower's whole plot has protection from at least one Lepidopteran pest of interest, and a substantial majority of the plot also has protection from at least one Coleopteran pest of interest.

In the event that refuge is required for Lepidopteran pests, the plot may also incorporate a third seed type that incorporates tolerance to Coleopteran pests but not Lepidopteran pests. This still provides protection from pests on an increased percentage of a given plot, but also provides some refuge insects to dilute any resistant Lepidopteran insects that survive.

While the invention is described predominantly using examples of pests affecting corn, the invention herein may also be applied to fields where resistance management is needed in the context of other crops, including soybeans, wheat, barley, sorghum, cotton, and the like. The invention may also be used in combination, such that multiple pests may be controlled in the course of the method, whether by transgenic means or otherwise.

In some embodiments, one or both of the pest resistant crop plants are further treated with a pesticidal or insecticidal agent. A “pesticidal agent” is a pesticide that is supplied externally to the crop plant, or a seed of the crop plant. The term “insecticidal agent” has the same meaning as pesticidal agent, except its use is intended for those instances wherein the pest is an insect. Pesticides suitable for use in the invention include pyrethrins and synthetic pyrethroids; oxadiazine derivatives (see, e.g., U.S. Pat. No. 5,852,012); chloronicotinyls (see, e.g., U.S. Pat. No. 5,952,358); nitroguanidine derivatives (see, e.g., U.S. Pat. Nos. 5,633,375; 5,034,404 and 5,245,040.); triazoles; organophosphates; pyrrols, pyrazoles and phenyl pyrazoles (see, e.g., U.S. Pat. No. 5,952,358); diacylhydrazines; carbamates, and biological/fermentation products. Known pesticides within these categories are listed in, for example, The Pesticide Manual, 11th ed., (1997) ed. C. D. S. Tomlin (British Crop Protection Council, Farnham, Surrey, UK). When an insecticide is described herein, it is to be understood that the description is intended to include salt forms of the insecticide as well as any isomeric and/or tautomeric form of the insecticide that exhibits the same insecticidal activity as the form of the insecticide that is described. The insecticides that are useful in the present method can be of any grade or purity that passes in the trade as such insecticide. In still other embodiments, the first and/or second pest resistant crop plant is optionally treated with acaricides, nematicides, fungicides, bactericides, herbicides, and combinations thereof.

To the extent transgenes or native resistance genes are used, various promoters known in the art may also be employed in order to either increase or decrease the expression of the target protein, and thereby affect the amount of refuge still required. If the goal is lower or no refuge for a pest, most often greater expression will be desired to produce a “high dose” of the expressed protein. In some instances, however, a greater number of adult pests may be preferable in order to monitor the development of resistance or to produce a greater refuge for one pest, and as such lowering expression may be appropriate.

Although the foregoing embodiments have been described in some detail by way of illustration and example for purposes of clarity of understanding, it will be obvious that certain changes and modifications may be practiced within the scope of the appended claims. All publications and patent applications mentioned in the specification are indicative of the level of those skilled in the art to which the embodiments of this invention pertain. All publications and patent applications are herein incorporated by reference.

What is claimed is:

1. A method of reducing the development of resistant pests in a field of transgenic pest resistant crops comprising the steps of:
a) mixing seed of a first transgenic pest resistant crop with seed of a second transgenic pest resistant crop to provide a seed mixture wherein said first pest resistant crop and said second pest resistant crop are pesticidal to the same target pest but through a different mode of pesticidal action, wherein said seed mixture consists of from about 99% to about 1% of said first transgenic pest resistant crop and of from about 1% to about 99% of said second transgenic pest resistant crop; and
b) planting said seed mixture.

2. The method of claim 1, wherein said pest is selected from the group consisting of: western corn rootworm, northern corn rootworm, Mexican corn rootworm, southern corn rootworm, and combinations thereof.

3. The method of claim 1, wherein said pest is western corn rootworm.

4. The method of claim 1, wherein said different mode of pesticidal action comprises binding semi-competitively or non-competitively in the gut membrane of said same target pest.

5. The method of claim 1 further comprising treating said first transgenic pest resistant crop seed and/or said second transgenic pest resistant crop seed with a pesticidal agent.

6. The method of claim 5, wherein said pesticidal agent is selected from the group consisting of: an insecticide, an acaricide, a nematicide, a fungicide, a bactericide, a herbicide, or a combination thereof.

7. The method of claim 6, wherein said pesticidal agent is an insecticide.

8. The method of claim 7, wherein said insecticide is selected from the group consisting of: a pyrethrin, a synthetic pyrethrin, an oxadizine, a chloronicotinyl, a nitroguanidine, a triazole, an organophosphate, a pyrrol, a pyrazole, a phenol pyrazole, a diacylhydrazine, a biological/fermentation product, a carbamate, or a combination thereof.

9. The method of claim 1, wherein said first transgenic pest resistant crop plant produces Cry34/35 proteins and said second transgenic pest resistant crop plant produces a Cry3 protein.

10. The method of claim 1, wherein said first transgenic pest resistant crop plant produces Cry34/35 proteins and said second transgenic pest resistant crop plant produces a Cry1F protein.

11. The method of claim 1, wherein said first transgenic pest resistant crop plant produces a Cry1A(b) protein and said second transgenic pest resistant crop plant produces a Cry1F protein.

12. The method of claim 1, wherein said first transgenic pest resistant crop plant produces a Cry1A(b) protein and said second transgenic pest resistant crop plant produces a Cry9 protein.

13. The method of claim 1, wherein said first transgenic pest resistant crop plant produces a Cry1A(b) protein and said second transgenic pest resistant crop plant produces a Cry2 protein.

14. The method of claim 1, wherein said first transgenic pest resistant crop plant produces a Cry1F protein and said second transgenic pest resistant crop plant produces a Cry2 protein.

15. The method of claim 1, wherein said first transgenic pest resistant crop plant produces a Cry1A(b) protein and said second transgenic pest resistant crop plant produces a Cry2 protein and a Vip3A protein.

16. The method of claim 1, wherein said first transgenic pest resistant crop plant produces a Cry1F protein and said second transgenic pest resistant crop plant produces a Cry2 protein and a Vip3A protein.

17. The method of claim 1, wherein said first transgenic pest resistant crop plant produces a Cry1A(b) protein and said second transgenic pest resistant crop plant produces a Cry1F protein and a Vip3A protein.

18. The method of claim 1, wherein said first transgenic pest resistant crop plant and/or said second transgenic pest resistant crop plant further contains a herbicide resistance gene selected from the group consisting of: glyphosate N-acetyltransferase (GAT), 5-enolpyruvylshikimate-3-phosphate synthase (EPSPS), phosphinothricin N-acetyltransferase (PAT) or a combination thereof.

19. A method of reducing the development of resistant pests in a field of transgenic pest resistant crops comprising the steps of:
a) mixing a first type of seed and a second type of seed to produce a seed mixture, wherein the first type of seed is seed of a transgenic pest resistant crop plant comprising a first transgene and a second transgene, the first type of seed having pesticidal activity against a first target pest and a second target pest, and wherein the second type of seed does not have pesticidal activity against the first target pest or the second target pest, wherein said seed mixture comprises about 90% to about 99% of the first type of seed and from about 10% to about 1% of the second type of seed; and
b) planting said seed mixture.

20. The method of claim 19, wherein said first target pest is selected from the group consisting of: western corn rootworm, northern corn rootworm, Mexican corn rootworm, southern corn rootworm, and combinations thereof.

21. The method of claim 19 wherein said first target pest is western corn rootworm.

22. The method of claim 19 wherein the first type of seed is pesticidal to at least one pest through at least two different modes of pesticidal action, the different modes of pesticidal action comprising binding either semi-competitively or non-competitively in the gut membrane of the at least one pest.

23. The method of claim 19 further comprising treating the first type of seed and/or the second type of seed with a pesticidal agent.

24. The method of claim 23, wherein said pesticidal agent is selected from the group consisting of pyrethrins and synthetic pyrethrins, oxadizines, chloronicotinyls, nitroguanidines, triazoles, organophosphates, pyrrols, pyrazoles, phenol pyrazoles, diacylhydrazines, biological/fermentation products, and carbamates.

25. The method of claim 19, wherein the transgenic pest resistant crop plant produces a protein selected from the group consisting of Cry34/35, Cry1F, Cry1A(b), Cry2, Cry3, Cry9 proteins or combinations thereof.

26. The method of claim 19, wherein the transgenic pest resistant crop plant produces a Cry1F protein and a Cry1A(b) protein.

27. The method of claim 19, wherein the transgenic pest resistant crop produces Cry34/35 proteins, a Cry1A(b) protein, and a Cry1F protein.

28. The method of claim 19, wherein said seed mixture comprises about 95% of the first type of seed and about 5% of the second type of seed.

29. The method of claim 19, wherein said first transgenic pest resistant crop plant or said second transgenic pest resistant crop plant further contains a herbicide resistance gene selected from the group consisting of: glyphosate N-acetyltransferase (GAT), 5-enolpyruvylshikimate-3-phosphate synthase (EPSPS), phosphinothricin N-acetyltransferase (PAT) or a combination thereof.

30. A method of managing pest resistance in a plot of pest resistant crops comprising:
a) providing seed of a first transgenic pest resistant crop, the first transgenic pest resistant crop expressing a first transgene and a second transgene, the first transgene providing increased tolerance or resistance to at least one Coleopteran pest and the second transgene providing resistance to at least one Lepidopteran pest,
b) providing seed of a second transgenic pest resistant crop, the second transgenic pest resistant crop expressing a third transgene, the third transgene providing resistance to the same at least one Lepidopteran pest through a different mode of pesticidal action than the second transgene, and
c) planting the seed of the first transgenic pest resistant crop and the seed of the second transgenic pest resistant crop in a plot.

31. The method of claim 30 wherein the at least one Coleopteran pest is selected from the group consisting of western corn rootworm, northern corn rootworm, Mexican corn rootworm, southern corn rootworm, or combinations thereof.

32. The method of claim 30 wherein the at least one Lepidopteran pest is selected form the group consisting of European corn borer, southwestern corn borer, corn earworm, fall armyworm, black cutworm, western bean cutworm, or combinations thereof.

33. The method of claim 30 further comprising treating said first transgenic pest resistant crop seed and/or said second transgenic pest resistant crop seed with a pesticidal agent.

34. The method of claim 30 wherein said pesticidal agent is selected from the group consisting of: an insecticide, an acaricide, a nematicide, a fungicide, a bactericide, a herbicide, or a combination thereof.

35. The method of claim 30 wherein said pesticidal agent is an insecticide.

36. The method of claim 30 wherein said insecticide is selected from the group consisting of: a pyrethrin, a synthetic pyrethrin, an oxadizine, a chloronicotinyl, a nitroguanidine, a triazole, an organophosphate, a pyrrol, a pyrazole, a phenol pyrazole, a diacylhydrazine, a biological/fermentation product, a carbamate, or a combination thereof.

37. The method of claim 30, wherein said first transgenic pest resistant crop plant and/or said second transgenic pest resistant crop plant further incorporate a herbicide resistance gene selected from the group consisting of: glyphosate N-acetyltransferase (GAT), 5-enolpyruvylshikimate-3-phosphate synthase (EPSPS), phosphinothricin N-acetyltransferase (PAT) or a combination thereof.

38. The method of claim 30 wherein expression of the first transgene causes expression of Cry34/35 proteins in a plant.

39. The method of claim 30 wherein expression of the second transgene causes expression of a Cry1F protein in a plant.

40. The method of claim 30 wherein expression of the third transgene causes expression of a protein in a plant, wherein the protein is selected from the group consisting of Cry1A(b), Cry1F, Cry2, and Cry9 proteins.

41. The method of claim 40 wherein the protein is a Cry1A(b) protein.

42. The method of claim 40 wherein the protein is a Cry1F protein.

43. The method of claim 30 wherein the first transgenic pest resistant crop expresses a fourth transgene and the second transgenic pest resistant crop expresses a fifth transgene, and wherein expression of the first transgene causes expression of Cry34/35 proteins in a plant, expression of the second transgene causes expression of a Cry1F protein in a plant, expression of the third transgene causes expression of a Cry1F protein in a plant, expression of the fourth transgene causes expression of a Cry1A(b) protein in a plant, and expression of the fifth transgene causes expression of a Cry1A(b) protein in a plant.

44. The method of claim 43 wherein the seed of the first transgenic pest resistant crop comprises at least about 90% of the total crop planted in the plot.

45. The method of claim 30 further comprising: providing seed of a third transgenic pest resistant crop, the second transgenic pest resistant crop expressing a fourth transgene, the fourth transgene providing resistance to the same at least one Coleopteran pest, but not providing resistance to the same at least one Lepidopteran pest.

46. The method of claim 45 wherein the fourth transgene and the second transgene comprise the same transgene.

47. The method of claim 45 wherein expression of the fourth transgene causes expression of a protein in a plant, wherein the protein is selected from the group consisting of Cry34/35 and Cry3 proteins.

48. The method of claim 45 wherein the first transgenic pest resistant crop comprises at least about 85% of the total crop plants in the plot.

49. The method of claim 45 wherein the first transgenic pest resistant crop comprises at least about 90% of the total crop plants in the plot.

50. The method of claim 45 wherein the first transgenic pest resistant crop comprises at least about 95% of the total crop plants in the plot.
